(19) United States
(12) Patent Application Publication
(10) Pub. No.: US 2026/0220100 A1
(43) Pub. Date: Jul. 30, 2026

(54) METHOD AND SYSTEM FOR PROCESSING DATA

(71) Applicant: ObjectSecurity LLC, San Diego, CA (US)

(72) Inventors: Ulrich LANG, San Diego, CA (US); Reza FATAHI, Encino, CA (US); Jason KRAMER, Studio City, CA (US); Trevor Thomas, Verona, WI (US); Holmes Chuang, Las Vegas, NV (US); Federico Aragon, San Diego, CA (US)

(73) Assignee: ObjectSecurity LLC, San Diego, CA (US)

(21) Appl. No.: 18/237,305

(22) Filed: Aug. 23, 2023

Related U.S. Application Data
(60) Provisional application No. 63/400,346, filed on Aug. 23, 2022.

(51) Int. Cl. G06F 16/215

(52) U.S. Cl. CPC G06F 16/215

(57) ABSTRACT

Method and system for composing a data cleansing pipeline formed of data transformations, including loading, input data for the data cleansing pipeline; configuring, a series of at functional block and connecting edge, encapsulating the sequence of data transformations in the data cleansing pipeline; visualizing properties, modifications, and/or other characteristics of the data and/or data cleansing pipeline through at least one data visualization method; testing of the data cleansing pipeline via real-time feedback wherein configuration modifications to functional blocks propagate an immediate change in the data cleansing pipeline's output; Integrating data ingress sources, data egress targets, and data transformation into the data cleansing pipeline; and finalizing the data cleansing pipeline, wherein the data cleansing pipeline is assigned metadata.

This application claims priority to U.S. Provisional Application No. 63/400,346 entitled “Method and System for Cybersecurity in a No or Low Code Environment”, which was filed on Aug. 23, 2022, and which is incorporated herein by reference.

This invention was made with government support under FA820421C0004 awarded by United States Air Force. The government has certain rights in the invention.

### BACKGROUND OF THE INVENTION

### 1. Field of the Invention

This application relates generally, but not exclusively, to a novel method relating to data science, including but not limited to, data cleansing, data preprocessing, artificial intelligence, and/or machine learning, etc. More particularly, functions of the invention are directed at configuring functional blocks to create a pipeline to perform tasks such as, but not limited to, deduplicating data, removing data, filtering data, sorting data, using Artificial Intelligence and Machine Learning (AI/ML) to analyze and/or modify data, transform data, generate synthetic data, preprocess data for AI/ML, generate visualizations, optimize data for machine learning, detect cybersecurity vulnerabilities, train new AI/ML models, and/or fine-tune AI/ML models, etc.

### 2. Description of the Related Art

Data cleansing is a process utilized by various computing processes, applications, and activities within an organization to ensure that data used for analysis, decision-making, and reporting is accurate, reliable, and consistent. Data cleansing is important for several reasons, and its significance lies in the numerous benefits it brings to data-driven organizations and processes.

Data cleansing is done today using a combination of manual and automated techniques, supported by select tools and technologies. In general, there are five categories to consider, which are machine learning-based, sample-based, expert-based, rules-based, and framework-based mechanisms. The process usually involves several steps aimed at detecting and correcting errors, inconsistencies, and inaccuracies in the data. Data issues that can be expressed as rules including standardizing formats, removing duplicate records, filling in missing values, and correcting common spelling errors.

Data often results from complex networks that represent various real-world systems. Overlapping detection from one of the five categories to detect data issues has a significance to a wide variety of applications to ensure that the data is correct for autonomous operations. Modularization has been demonstrated to improve the flexibility and general effectiveness of various frameworks and models that can be adapted to detect similarities and differences in modular representations and structures resulting from various preprocessing techniques.

Conventional tools and approaches to data cleansing typically rely on manually modifying data and utilizing scripts and libraries, such as pandas and numpy in Python, to cleanse data for downstream analyses. Conventional software tools such as Microsoft Excel allow users to manipulate data within a table with built-in functions and/or develop Visual Basic programs to achieve the data conversion. These current tools and approaches have many challenges and downsides. They can be time consuming, difficult to change and update, difficult to view results at intermediate steps, difficult to integrate in other environments, and difficult to export or adapt to new datasets. Being able to generate, add, remove, and modify data cleansing steps would save time, require less effort, require less expertise, etc. In addition, there is a need to view data cleansing steps in real-time and make adjustments to intermediate steps without having to execute the full data cleansing pipeline again. There is also a need to be able to reuse data cleansing steps across multiple datasets, systems, use cases, etc. There is a need to be able to cleanse data for AI/ML and then train machine learning models from that data in a user-friendly manner. Lastly, there is a need to be able to branch data cleansing steps easily into multiple data cleansing processes.

While data cleansing is widely applicable, one example use case is related to processing cybersecurity data: The cybersecurity tool landscape is rapidly expanding and becoming more complex. It is becoming increasingly difficult for organizations to effectively manage all of the cybersecurity tools they utilize due to the growing complexity of network environments, increasingly advanced and frequent attacks, an abundance of information being ingested from cybersecurity tools, and the demand for building correlations between results from various logs and tools. Additionally, security teams are often limited in staff while consistently having a backlog of tasks, mitigations, logs, and a requirement to ensure security compliance guidelines are being followed. Although conventional cybersecurity tools provide valuable insight into the activities within a system or network and its threat landscape, they are often built (sometimes intentionally) to be aggressive in their reporting of threats, leading to a large volume of security alerts. The large volume and aggressiveness of alerts can result in more false positives, which further exacerbates the issue of managing a complex toolset while limited in available resources, since each alert needs to then be individually assessed as an actual threat or a false positive. Security audits are carried out across multiple systems and tools, consuming time and increasing the need for having a high level of cybersecurity experience and expertise. High volumes of security alerts can accumulate if there are not enough resources to address them in a timely manner.

Management of a secure database and its access logs even further complicates risk management, since databases have their own set of cybersecurity challenges that need to be addressed, such as authentication, network and data access controls, data encryption, auditing, vulnerabilities and patches to database software, database compliance, backups, etc. Securing databases is important, since they can contain sensitive data and intellectual property. This is especially true for government databases, and it can be costly if an adversary gains unauthorized access to classified or controlled data. The compromised systems need to be investigated, remediated, and cleared of threats and vulnerabilities.

These factors lead to increased risk that vulnerabilities and threats go undetected or are not responded to in a sufficient amount of time. Backlogs of security logs and alerts can result in issues not being looked at until months later, long after an attack or data breach. At that point the only thing that can be done is to assess damages and secure the system (esp. if there are still ongoing attacks), since it is far too late to stop the initial imminent threat. Stopping the threat would involve dissecting a multitude of logs and alerts from all tools and connected systems to reveal the extent of the attack, a lock down of all vulnerable systems, and writing of a report on discovered attacks and damages. The damages from an attack can take days, weeks, or even months to resolve and recover from, bringing on an additional logjam of neglected logs and alerts. These challenges make being resilient to threats, or responding to and stopping them in real-time, much more difficult to accomplish.

Security teams are also concerned with insider threats, where someone within an organization has inside information about the company's systems, security, or any confidential and proprietary information, and has malicious intent to steal or sell data, assist an adversary get access to data, attack systems, and/or sabotage operations. Insider threats can even be unintentional. For example, staff may lack adequate knowledge of organization security practice or policy, and as a result accidentally expose confidential security credentials. Staff may also fall victim to phishing attacks or social engineering, or fail to keep their own systems up to security standards. Hackers can also obtain a user's credentials from a previous data leak, cracking passwords, etc. It is not enough to only monitor systems and databases for outside attacks. Secure systems have to be proactive and reactive against insider threats as well. In order to mitigate against these threats and vulnerabilities, there is a requirement for expertise that is often high and may be prohibitive to many organizations, especially smaller ones. Furthermore, there is no guarantee that an organization will be able to acquire the talent needed to mitigate against these threats and vulnerabilities.

### SUMMARY OF THE INVENTION

Herein are some examples of how the invention may be implemented. Note this list is not exhaustive, and the invention may be created in some other manner similar in function, but not within the example's exact specification. It is therefore an object of the invention to provide:
-manual, semi-automated, and/or automated data cleansing, wherein zero or more data (dataset) may be received by the data-cleansing system, zero or more nodes may be configured for performing one or more action on the data, such as but not limited to transforming, removing, duplicating, deduplicating, modifying, and/or generating data, and/or providing data and/or rules that can be applied to other datasets. Each node may be connected to zero or more other services, such as a backend service, cloud service, server-side application, etc., that performs the actions configured in the nodes. Nodes may perform actions on zero or more datasets, and/or may perform actions on segments of data in zero or more datasets.
nodes in a user interface (UI), such as but not limited to a command line interface (CLI), web interface, and/or software application, etc., that can be configured in a data cleansing pipeline to perform zero or more actions on data for example concurrently and/or sequentially. Each node may have zero or more inputs and/or zero or more outputs, as well as zero or more edges that connect a node to one or more nodes (including the same node and/or other nodes). Nodes may include, but are not limited to, nodes that aggregate data from one or more data sources, nodes that perform mathematical calculations on data, nodes that generate AI/ML models from data, nodes that use the data as input to a trained AI/ML model, nodes that remove data, nodes that sort data, nodes that filter data, nodes that export data, nodes that generate synthetic data (e.g., for AI/ML), nodes that preprocess data (e.g., for AI/ML), nodes that visualize data, nodes that deduplicate data, nodes that merge data from multiple datasets, nodes that replace data, and/or nodes that split data into one or more datasets, etc.
nodes in a user interface (UI), wherein one data cleansing pipeline can be configured as a single node represented in a different data cleansing pipeline, thereby performing the full sequence(s) of nodes but only represented as a single node containing zero or more inputs and/or zero or more outputs. Nodes representing a data cleansing pipeline may also be used for example iteratively and/or recursively, wherein a node representing a data cleansing pipeline may for example have an edge connecting itself to itself or another node representing a data cleansing pipeline.
creating rule nodes, wherein configurations may be made within each individual node, thus allowing nodes of the same type to perform different actions within each node instance. Created rule nodes may be moved, reordered, removed, modified, duplicated, etc.
real-time actions, including (but not limited to) previewing, updating, and/or execution of data cleansing pipeline and/or individual node actions on zero or more datasets. For each data cleansing pipeline and/or individual node, data may be, for example (but not limited to), exported, visualized, and/or shared, etc. For example, when a single node and/or zero or more input datasets are modified, the node itself, subsequent downstream nodes, and/or the full data cleansing pipeline may preview, update, and/or execute actions based on the modifications made in real time. Users may also configure which nodes and/or which data cleansing pipelines receive real-time updates. For example, a user may set the first five nodes in a sequential data cleansing pipeline to receive real-time updates, but subsequent nodes may not receive real-time actions until the user, for example (but not limited to), executes the full data cleansing pipeline, provides new input data, pushes a physical button, and/or trigger configured by the user finds that all conditions required are true, etc. Real-time actions may, for example, be temporarily paused, for one or more nodes and/or data cleansing pipelines.
history of any data cleansing pipeline and/or node, including but not limited to, for example which organization and/or user made the changes, changes made to the order, type, and edges stemming from nodes, changes made to individual node parameters, history of data that each data cleansing pipeline and/or individual node has received, the actions performed on each dataset, and/or history of data cleansing steps made to a single dataset, etc.
cybersecurity of zero or more datasets received from zero or more cybersecurity related tools, applications, logs, audits, and/or scripts. This data may be received in real-time through an API from a cybersecurity tool, such as (but not limited to), binary analysis, network analysis, penetration testing, security system, anti-virus, identity and access management, access control, intrusion detection system, and/or endpoint security tool, etc. The data cleansing pipeline may be configured to preprocess, cleanse, monitor, and/or analyze data to, for example (but not limited to) categorize, highlight, remove, and/or partition alerts, anomalies, threats, weaknesses, vulnerabilities, exploits, and/or logs. For example, the data cleansing pipeline may be configured to continuously monitor data from zero or more cybersecurity tools to create a baseline of normal and/or expected behavior over a period of time and then detect anomalies and/or deviations from the baseline and alert the user. For example, the data cleansing pipeline may be configured to visualize ongoing cybersecurity alerts and their associated data. For example, the data cleansing pipeline may be used to associate data pertaining to an alert, anomaly, threat, weakness, vulnerability, exploit, and/or log with other data that occurred at the same and/or similar time. If a threat is detected from a particular IP address, the data cleansing pipeline may be configured to view and/or visualize one, some, and/or all prior instances in which that IP address was detected in zero or more datasets from zero or more cybersecurity related tools.
a data cleansing pipeline may be used on, for example (but not limited to) a continual basis, periodic basis, and/or contextual basis, wherein the same nodes may be used on data that has not yet been received by the system. A data cleansing pipeline may concatenate new data received by the system to, for example (but not limited to), a dataset, a database, visualizations, and/or one or more outputs from the data cleansing pipeline. Real-time actions may be performed on newly received data by the data cleansing pipeline.
a data cleansing blueprint may contain, but is not limited to, the inputs, outputs, properties, parameters, and/or edges, etc., of the nodes in a data cleansing pipeline. Data cleansing blueprints may be imported, exported, and/or modified, etc. Data cleansing blueprints may be imported fully to generate a duplicate data cleansing pipeline. Data cleansing blueprints may be imported as a singular data cleansing pipeline node in a different data cleansing pipeline. Data cleansing blueprints may be exported and/or shared between multiple devices and/or different data-cleansing systems. Data cleansing blueprints may be exported in a readable format (e.g., JSON, XML, CSV, and/or TXT, etc.) and/or compressed/encrypted format, etc.
a data cleansing pipeline may be used to validate the inputs and/or outputs of zero or more datasets, nodes, etc. For example, a data cleansing pipeline may alert a user if their data does not meet validation requirements, such as (but not limited to) outliers, invalid categories, invalid string length, invalid data types, and/or anomalies, etc. For example, a data cleansing pipeline may stop and/or modify downstream actions, such as (but not limited to), not returning data to a system, returning an error upon receiving a GET request for data, preventing export of data, running a cybersecurity script, and/or sending an API call, etc.
a data cleansing pipeline may be used to visualize data from zero or more datasets at any intermediate node and/or the full data cleansing pipeline. A data cleansing pipeline may branch into multiple datasets that may all be visualized. Visualizations may be updated in real time. Visualizations may include, but are not limited to, bar charts, scatter plots, graphs, pie charts, line charts, histograms, heat maps, box plots, choropleth maps, waterfall charts, flow charts, calendars, multi-set bar charts, and/or radar charts, etc.
a data cleansing pipeline may be used to optimize data to prepare it for AI/ML training. For example, it may aggregate the data into training, validating, and testing datasets. It may, for example (but not limited to), select hyperparameters (e.g., optimal hyperparameters), perform fine-tuning, select the optimal model, and/or encode data, etc. A data cleansing pipeline may train one or more new models and/or fine-tune existing models received by the system. Types of models may include, but are not limited to, object detection, image classifiers, natural language processing, generative models, Large Language Models (LLMs), and/or transformers, etc.
a data cleansing pipeline may be used to generate synthetic data. This data may be, but is not limited to, an expansion of existing data, and/or a new dataset, etc. For example, synthetic data may be used to train one or more AI/ML models when there is not enough data to train a model accurately. Data may be based on original data, may be configured through rules (e.g., regular expressions, etc.), may be generated using AI/ML etc.
a data cleansing pipeline may be integrated into (but not limited to) one or more other applications, tools, programs, scripts, websites, pipelines (e.g., DevSecOps, and/or CI/CD, etc.) and/or devices, etc. It may be configured to receive data at different times of the day and may be configured to only perform actions from nodes when all expected data is received within a single day. A single data cleansing pipeline's completion may trigger another data cleansing pipeline to start.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. For example, singular or plural use of terms are illustrative only and may include zero, one, or multiple; the use of “may” signifies options; modules, steps and stages can be reordered, present/absent, single, or multiple etc.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 depicts an example of the data cleansing system including inputs, outputs, and/or purposes;

FIG. 2 depicts an example UI/UX for user login and authentication to the data cleansing system;

FIG. 3 depicts an example UI/UX for ingressing data into the data cleansing system;

FIG. 4 depicts an example UI/UX for configuring nodes and connecting edges to define a data cleansing pipeline within the data cleansing system;

FIG. 5 depicts a functional diagram for generating a rules-based data cleansing and validation pipeline;

FIG. 6 depicts a functional diagram for losslessly producing a blueprint file, encoding all data transformations required to perform data cleansing within it;

FIG. 7 depicts an example UI/UX for selecting between various node categories in the data cleansing system;

FIG. 8 depicts a functional diagram for performing just-in-time testing on functional units of a data cleansing pipeline;

FIG. 9 depicts a functional diagram for receiving validation and/or feedback while performing just-in-time testing on functional units of a data cleansing pipeline;

FIG. 10 depicts a functional diagram for adding data input/output-related nodes to a data cleansing pipeline;

FIG. 11 depicts a functional diagram for adding Boolean-logic-based nodes to a data cleansing pipeline;

FIG. 12 depicts a functional diagram for adding data-visualization-related nodes to a data cleansing pipeline;

FIG. 13 depicts a functional diagram for adding AI/ML-based nodes to a data cleansing pipeline;

FIG. 14 depicts a functional diagram for adding generic nodes to a data cleansing pipeline, wherein such generic nodes perform data transformations often considered standard in most data cleansing systems;

FIG. 15 depicts a functional diagram for incorporating an AI/ML model as a node in a data cleansing pipeline;

FIG. 16 depicts a functional diagram for training an AI/ML model that exists as a node in a data cleansing pipeline;

FIG. 17 depicts a functional diagram for enabling a user to produce and fine-tune an AI/ML model that exists as a node in a data cleansing pipeline; and

FIG. 18 depicts a functional diagram as an example of how the data cleansing system may be used to cleanse and analyze cybersecurity-related data.

### DETAILED DESCRIPTION

### Terminology

For this specification, terms may be defined as follows:
Classifier Model—A machine learning algorithm that automatically orders or categorizes data into one or more of a set of classes.

Clean Data—Accurate, complete, and consistent data, especially in a computer system or database. Clean data is often cohesive and consistent with other similar sets of data in the system. Clean data has often been normalized and/or cross-checked with a validated ruleset. Clean data contains neither formatting errors nor logical errors.
Clean/Dirty Classifier Model—A classifier model wherein the set of classes consists of and is limited to (1) dirty data and (2) clean data.
Commercial Transaction Data—Data pertaining to, but not limited to, product orders, invoices, payments, client/customer interactions, and/or other financial, commercial, or banking-related information most often that may be associated with a pair of individuals or organizations. Examples of commercial transaction Data includes fields such as, but not limited to, customer/client name, date of purchase/transaction, quantity of money, type of currency, location of transaction, and/or products or services exchanged. Examples of dirty commercial transaction data may include but are not limited to entries lacking a customer/client name, unspecified currency type, and/or an incorrectly listed quantity of money.
Computer Vision System Data—Data pertaining to, but not limited to, the practice of acquiring, processing, analyzing, and/or understanding digital images, most often for example involving the extraction of high-dimensional data for use in an AI/ML model. Examples of computer vision system data may include, but are not limited to, video sequences, camera views, 3D-scanner information, 3D point clouds from LiDaR sensors, medical scanning devices, and/or common digital image formats (e.g., PNG, JPG, GIF, etc.). Examples of dirty computer vision system data may include but are not limited to incorrectly labeled image training data, corrupted image formats, and/or null, blank, or redundant images.
Connecting Edge—A graphical representation, typically for example a line or curved edge, which describes the relationship between the data output of one node and the data input of another node. If two nodes share a connecting edge, one node sends its data output to the input of the other node.
Cybersecurity Log Data—Data pertaining to, but not limited to, network monitoring, access logging, alerting, alarming, file integrity, cryptographic information, and/or other security events most often that may be associated with a monitored local or air-gapped computer network. Examples of cybersecurity log data may include fields such as, but not limited to failed login sessions, deleted files, unauthorized resource access audits, IP addresses, DNS information, vulnerabilities, weaknesses, incidents, application logs, system logs, and/or file replication service logs. Examples of dirty cybersecurity log data may include but are not limited to incorrectly formatted datetimes, null or blank username entries, invalid IP address or domain names, and/or data that does not conform to a parent log schema or protocol (e.g., YAML, JSON, XML, etc.).
Data Cleansing—The process of identifying and remediating (or removing) dirty data in a data set. After cleansing, a data set should contain only clean data; data that is consistent with other similar data sets in the system.
Data Cleansing Blueprint—A data cleansing pipeline that has for example been losslessly stored as a single file, including all nodes, connecting edges, and clean/dirty classifier models associated with the data cleansing pipeline. A headless interpreter may interpret a data cleansing blueprint to perform data cleansing in data-reliant systems.
Data Cleansing Pipeline—A set of zero or more nodes and zero or more connecting edges that are used (for example in tandem) to perform data cleansing. Typically, a data cleansing pipeline is created in adherence to a specific kind of clean data, often with a well-defined data ruleset. Ideally, such a data cleansing pipeline can accept many unique sets of dirty data, transforming, normalizing, and cleansing each dirty data set into clean data.
Data Cleansing System—An application, software, web service, and/or program that enables the creation of one or more data cleansing pipelines via a user interface, typically by allowing users to configure a set of one or more nodes and one or more connecting edges. Such a system also enables the (for example lossless) export of data cleansing blueprints and may enables the user to train clean/dirty classifier models.
Data Egress—The process of data leaving a system, program, or network and transferring to an external location.
Data Ingestion—The process of data entering a system, program, or network from an external location and being stored persistently. Data ingestion often involves the cleansing of said ingested data before it is persistently stored.
Data Ingress—The process of data entering a system, program, or network from an external location.
Data Input Port—A graphical component that may be displayed one zero or more times on a node via the user interface. This component enables the attachment of one zero or more connecting edges. Such an attachment serves as a symbolic representation of another node sending data as input to this node.
Data Output Port—A graphical component that may be displayed one zero or more times on a node via the user interface. This component enables the attachment of one or more connecting edges. Such an attachment serves as a symbolic representation of this node sending data as output to another node.
Data Ruleset—A set of rules which govern, define, and/or enforces the requirements for a dataset to be considered as clean data. For example, a data ruleset may define clean data as being limited to a certain number of columns, including only dates of a certain format, and/or not included number above a certain size.
Data Transformation—The process of converting source data from one format or structure into target data of another format or structure. This includes both direct modifications to the source data, as well as an indirect passing of information, such as but not limited to the appending of external labels, the highlighting of specific sections in the source data, visualizing data, parsing data, processing data, analyzing data, and/or creating data based on (e.g., source and/or target) data etc.
Data Used for Prediction or Classification Tasks by a Machine Learning Model—Data pertaining to, but not limited to, the training of machine learning models for prediction, generation or classification tasks, most often for example involving the use of labeled tabular data to train multi-layer perceptron, logistic regression, Naïve Bayes, and/or k-nearest neighbors classifier-focused machine learning models. Examples of data used for prediction or classification tasks by a machine learning model include the data used to train ML models capable of natural language processes such as sentiment analysis and underlying language detection, email spam filters, content recommendation systems (e.g., those used by YouTube, Amazon, and Tik-Tok), generative AI systems, and/or weather pattern detection etc. Examples of dirty data used for prediction or classification tasks by a machine learning model include but are not limited to mislabeled data entries, null or blank entries, and/or data deem irrelevant or unrelated to the machine-learning classification task in question.
Data Visualization—The practice of designing and creating easy-to-communicate and easy-to-understand graphic or visual representations of complex quantitative and qualitative data.
Dataflow—A conceptualization of a sequence of data transformations wherein data transformations are nodes in a directed graph and data flows along the edges.
Dirty Data—Inaccurate, incomplete, or inconsistent data, especially in a computer system or database. Dirty data may consist of both formatting errors and/or logical errors.
Formatting Error—A type of data-entry error (introduced for example programmatically or erroneously via a human-in-the-loop) including but not limited to syntactical, typographical, spelling, or punctual inaccuracies. Examples of formatting errors include a misspelled word, duplicate entry, blank entry, or any other data-entry that is not cohesively formatted relative to other similar data sets in the system. Formatting errors may generally be detected using traditional computer programs, scripts, or other trivial methods.
Functional Block—A graphical representation that describes the function between one or more source data inputs and one or more target data outputs. A functional block may also define one or more other input parameters, including but not limited to text inputs, numeric inputs, and/or Boolean inputs, which are subsequently used as part of the function between source data and target data. A functional block includes one or more data transformations.
Headless Interpreter—A programming-language-agnostic computer algorithm that takes as input (1) a data cleansing blueprint and (2) a set of dirty data and performs data cleansing, resulting in a set of clean data.
Intermediate Data State—The current state of a dataset as it exists at a specific point in a data cleansing pipeline. The intermediate data state of a dataset includes all modifications made to it by all data transformations in the data cleansing pipeline which occurred before the aforementioned specific point. The intermediate data state for a dataset may be displayed via the intermediate data state viewer, a user interface element, whenever a particular node is selected by the user.
Logical Error—A type of data-entry error (introduced for example programmatically or erroneously via a human-in-the-loop) wherein no formatting errors are present, yet the data-entry still produces an unanticipated, unintended, or undesired outcome. Logical errors most often may manifest as incoherencies which are antithetical to some pre-conceived rule. Examples of logical errors include but are not limited to dates falling out of chronological order, data being assigned the wrong label, or an address that does not exist in the real world. Logical errors typically require a human observer and/or an AI/ML model to be detected and remediated.
Lossless Storage—A form of data compression that typically reduces data storage size without sacrificing any significant information in the process. The original data may be perfectly reconstructed from the compressed data with no loss of information.
Maintenance Data—Data pertaining to, but not limited to, the labor, policies, and/or procedures required for asset maintenance. Examples of maintenance data may include fields such as, but not limited to affected asset, manhours, type of maintenance, schematics, diagrams, schedules, and/or written descriptions of the maintenance that occurred. Examples of dirty maintenance data may include but are not limited to incorrectly explained inspection results, poorly quantified inventory levels, and/or anomalous maintenance metrics such as an abnormally high or low manhours entry.
Medical Data—Data pertaining to, but not limited to, health conditions, clinical metrics, behavioral information, reproductive outcomes, causes of death, quality of life, and/or other health-related information most often that may be associated with an individual or population. Examples of medical data may include fields such as, but not limited to, patient name, date of birth, blood-test results, emails, audio recordings, physician notes about a patient, and/or prescribed drugs. Examples of dirty medical data may include but are not limited to patients being listed with an incorrect date of birth, blood-test results pertaining to the wrong blood-type, and/or prescribed drugs being associated with the wrong side-effects.
Module—An encapsulation of a data cleansing pipeline that treats all data transformations associated with the data cleansing pipeline as if they were present in a single node. Modules may be imported and repurposed in other data cleansing pipelines. Modules enable complex data cleansing pipelines to be succinctly represented and duplicated.
Node—A functional block where the source data inputs, and target data outputs of the functional block may be directed via one or more connecting edges to one or more other nodes/functional blocks. A node may include one or more visual input fields that a user can interact with to provide additional input parameters, such as but not limited to text inputs, numeric inputs, and/or Boolean inputs.
Node Flow—Dataflow as it exists in the context of a data cleansing pipeline, wherein one or more nodes are connected with one or more connecting edges.
Node Input Parameter—A node may include one zero or more visual input fields that a user can interact with to provide additional input parameters, such as but not limited to text boxes, numeric inputs, checkboxes, and/or dropdown menus.
Tabular Data—Data consisting of or presented in rows and columns. Tabular data may include one or more tables. Tabular data is most often may be internally consistent, wherein a common formatting scheme is maintained throughout an entire table.
Workspace—A user interface element of the data cleansing system that displays and enables the user to configure a set of nodes and connecting edges. One or more workspaces may exist in the data cleansing system at once, with each representing for example a single data cleansing pipeline.

### 1) Embodiment of the Data Cleansing System

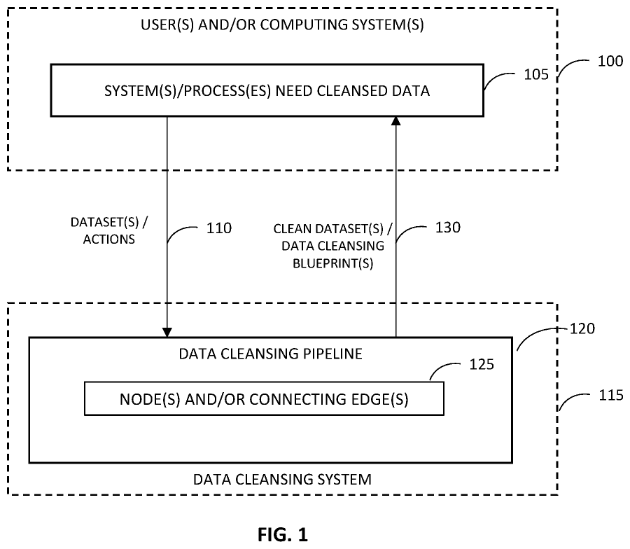

FIG. 1 depicts an example of a Data Cleansing System 115, wherein a User(s) and/or Computing System(s) 100 may interact with and/or may configure a set of one or more Nodes and/or Connecting Edges 125 to create a Data Cleansing Pipeline 120. A Data Cleansing Pipeline 120 may for example be used to cleanse dirty data provided to the Data Cleansing System 115 by, for example, the User(s) and/or Computing System(s) 100, resulting in (partly or fully) clean data. It may be used, for example (but not limited to), automatically cleanse data, normalize data across one or more datasets, generate synthetic data, visualize data, prepare data for data science, artificial intelligence, and/or machine learning, and/or train one or more models, etc. A Data Cleansing Pipeline 120 may perform actions, such as (but not limited to) sending data to an API, saving data to a system, dispatching an email, sending a text message, and/or sending data to an MLOps pipeline, etc. For example, if data is found to be beyond a set limit, an email may be sent alerting administrators in an organization. For example, if cybersecurity vulnerability data is received by a Data Cleansing Pipeline 120, and a vulnerability level is determined to be beyond a pre-determined threshold, then an email may be sent to cybersecurity administrators alerting them that a vulnerability may need to be addressed. Mitigations may also be configured in a Data Cleansing Pipeline 120. For example, for cybersecurity vulnerabilities discovered, API endpoints may be called to perform downstream mitigation actions, such as (but not limited to), deleting and/or encrypting file(s), and/or running a malware scan, etc. Data that may be cleansed, analyzed, visualized, and/or used in AI/ML training include, but are not limited to, text-based data, tabular data, images, videos, audio, and/or multimodal data, etc. Example types of data that may be analyzed include, but are not limited to, cybersecurity data, medical data, logistics data, and/or maintenance data, etc. Data cleansed by a Data Cleansing Pipeline 120 may be used for inference for an AI/ML model within a Data Cleansing Pipeline 120 and/or external to a Data Cleansing Pipeline 120. Data within a Data Cleansing Pipeline 120 may be sent to a different Data Cleansing Pipeline 120.

### 1.1) Dataset Input

One or more User(s) and/or Computing System(s) 100, in respect to Systems and Processes in Need of Cleansed Data 105, may interact with and/or connect to a Data Cleansing System 115. Ways to interact include, but are not limited to, a web browser, desktop executable, and/or another user interface display method, etc. A user may manipulate a Data Cleansing System 115 by ingressing and/or egressing Dataset(s), and/or by Actions 110, including but not limited to configuring Nodes and/or Connecting Edges 125. Data may for example be in CSV, XLSX, XML, JSON, PNG, MOV, MP3, MP4, TXT, and/or other data formats. Data that is input may be configured by fetching data from an API endpoint. Data may be uploaded in a drag-and-drop box. Data may be uploaded by adding one or more file and/or directory paths. Data may include zero or more datasets. Data may not be received by a Data Cleansing System 115, and data may be generated within a Data Cleansing System 115 and/or used for downstream analyses.

### 1.3) Data Cleansing Pipeline—Node(s) and Connecting Edge(s)

When creating a Data Cleansing Pipeline 120, a user may add and/or configure Nodes and/or Connecting Edges 125 wherein each node may represent a functional block which may perform zero or more data transformations in support of for example normalizing, cleansing, and/or standardizing, etc., the data to a data ruleset. Nodes may be chained together via connecting edges, encapsulating a data cleansing pipeline. Nodes and/or Connecting Edges 125, as well as a full Data Cleansing Pipeline 120 may be copied, saved, grouped, ungrouped, exported, etc. A Data Cleansing Pipeline 120 or grouped nodes may be represented as a single node that performs the actions of multiple nodes.

### 1.4) Dataset(s)/Data Cleansing Blueprints

An example of output of a Data Cleansing System 115 may be a Clean Dataset and/or Data Cleansing Blueprint(s) 130. Output may be a visualization, email, API call(s), alarm, text message, and/or email, etc. A data cleansing blueprint may define sequence(s) of data transformations taken on dirty data to transform it into a clean state. A data cleansing blueprint may encapsulate a Data Cleansing Pipeline 120 and may be re-applied (such as a headless interpreter) to another dirty dataset of similar structure.

### 2) User Interface/User Experience (Application Login)

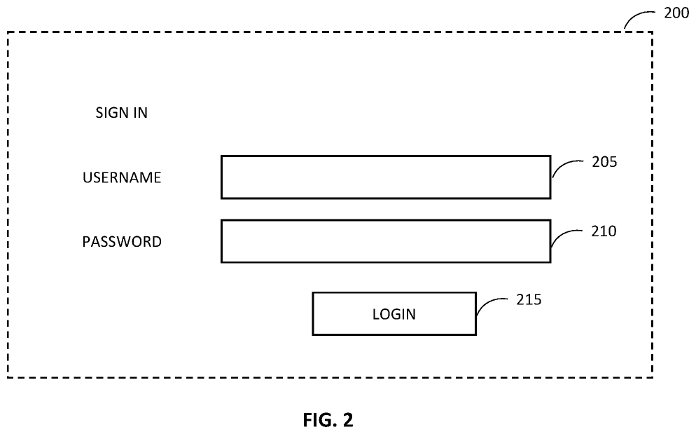

FIG. 2 depicts an example login screen for the Data Cleansing System 200. It demonstrates how the Data Cleansing System 200 may be accessed and how users may be authenticated. A login screen may accept a username 205 and/or a password 210 which a user may provide to gain access to the Data Cleansing System 200. It may utilize a separate backend that authenticates user(s). It may have a multi-factor authentication step. A user may access the Data Cleansing System 200 for example from a web browser, desktop executable, and/or another user interface display method. A login screen may also be comprised of a Login Button 215 which, when clicked, attempts to login the user to the Data Cleansing System 200.

### 3) User Interface/User Experience (Dataset Ingress and Workspace)

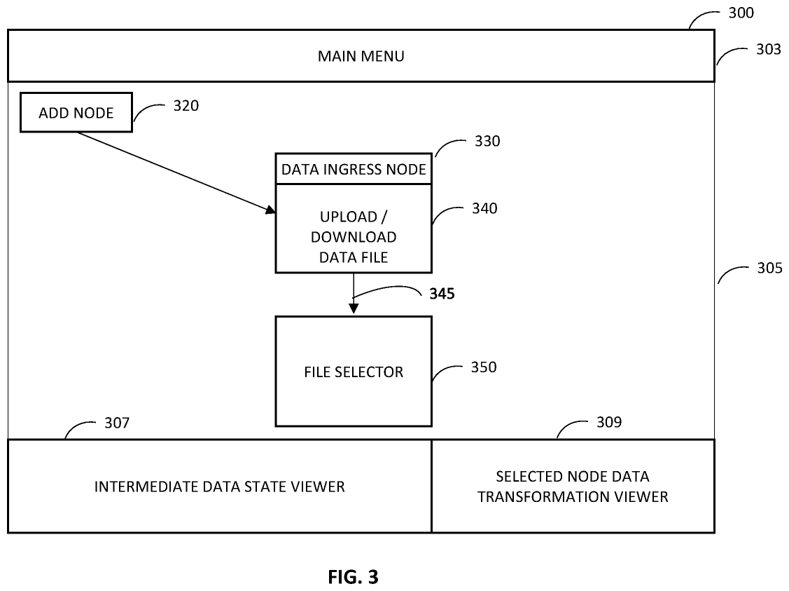

FIG. 3 depicts an example interface of the Data Cleansing System 300 wherein a Workspace 305 is shown comprising nodes, that may include (but is not limited to) an Add Node 320 button, Data Ingress Node 330, File Selector 350, Intermediate Data State Viewer 307, and/or Selected Node Transformation Viewer 309, etc. The purpose of this example is to illustrate an example process undertaken by a user when adding a Data Ingress Node 330 (e.g., a node that may be used to ingress data from an external source into a Data Cleansing System 300) and how such a process would alter the state of a user interface (e.g., by affecting the Intermediate Data State Viewer 307 and/or Selected Node Transformation Viewer 309). Additionally, a user may create multiple Workspaces 305 and can cycle between them by selecting the desired option from a Main Menu 303 navigation bar. This process may be reordered. It may include other steps not included in this figure and/or steps may be removed in other examples.

### 3.1) Add Node

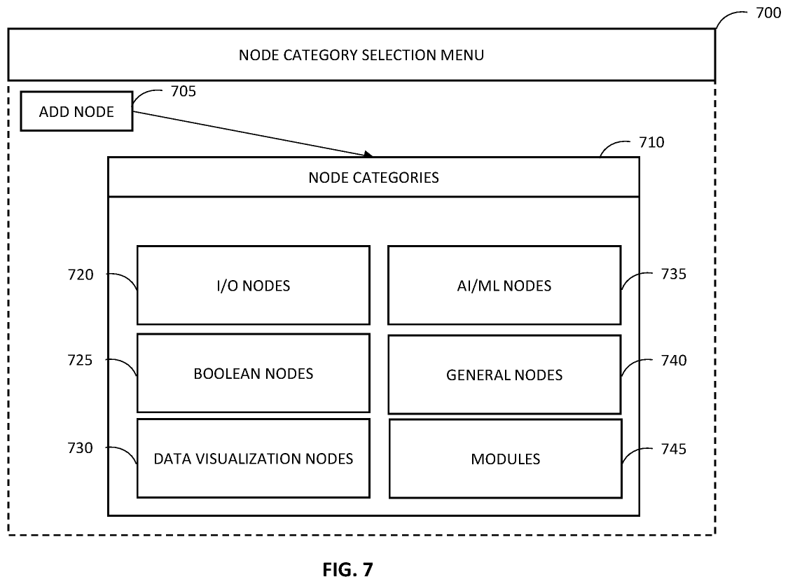

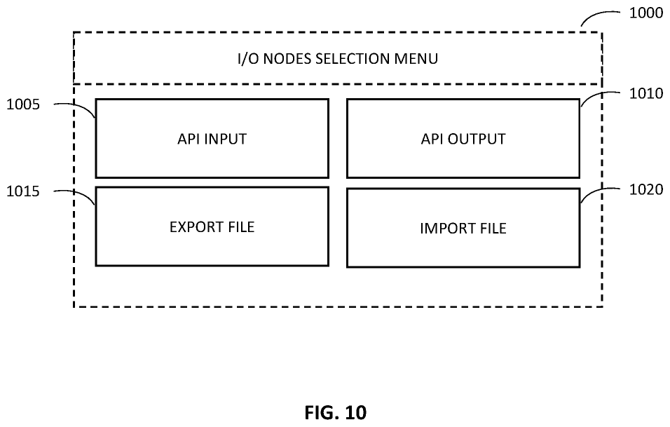

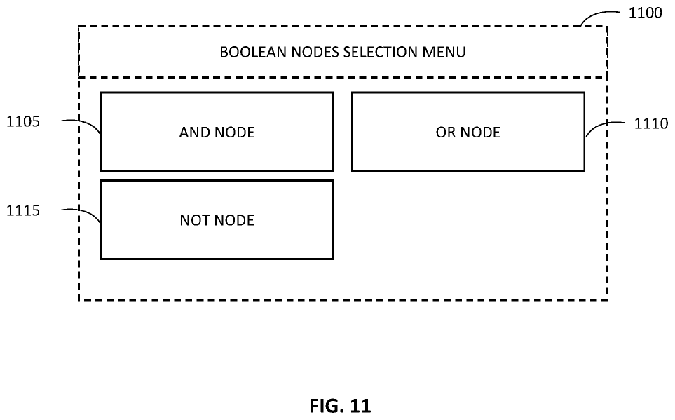

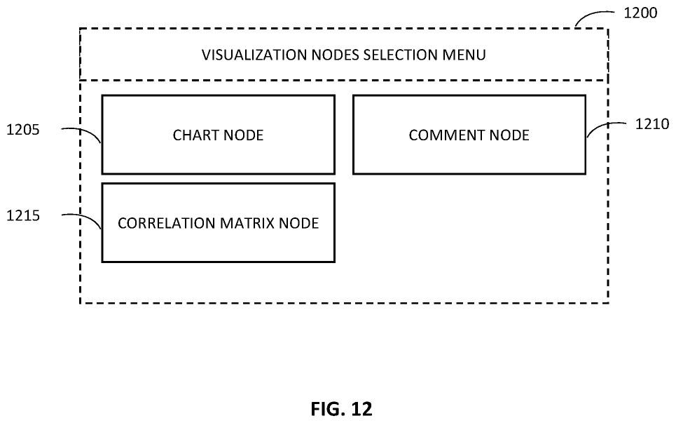

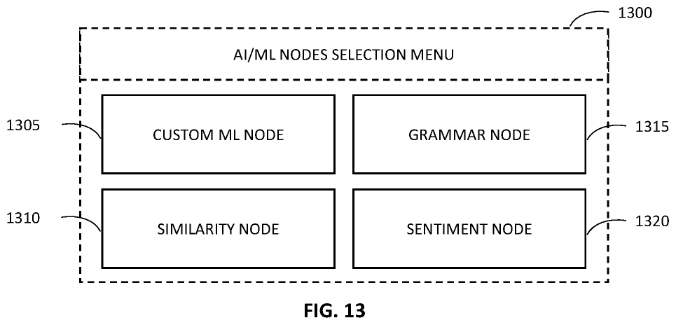

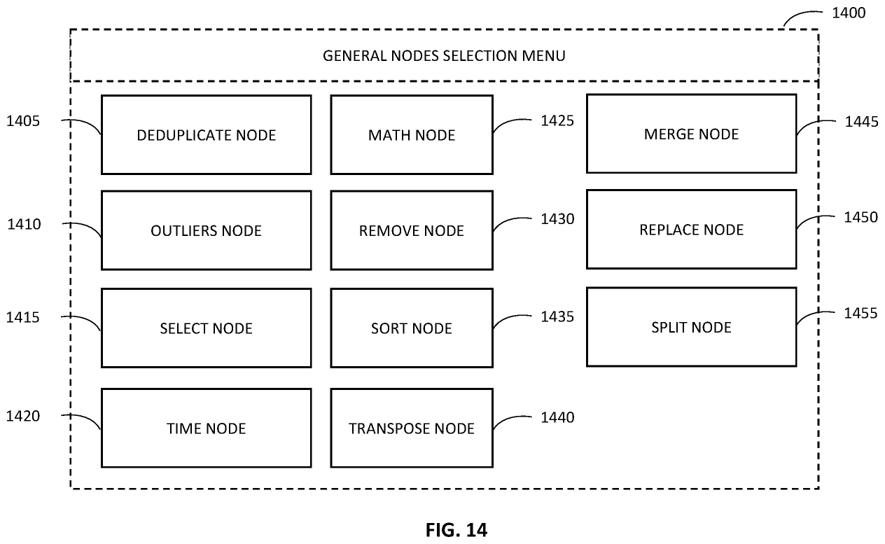

A node may be added to a Workspace 305 via an Add Node 320 button. This button may be interacted with, for example (but not limited to) by the user via a mouse click, finger touch using a touch-enabled device, and/or keyboard input, etc. Such an interaction may prompt additional user interface elements to be displayed (e.g., those defined in FIG. 7, FIG. 10, FIG. 11, FIG. 12, FIG. 13, and/or FIG. 14). Adding a node to a Workspace 305 may serve as an analogue for adding a node to the data cleansing pipeline referenced by a Workspace 305. A Workspace 305 may define the level of interactivity available to a user when modifying its referenced data cleansing pipeline. For the purposes of this example, a Data Ingress Node 330 is added to the Workspace 305.

### 3.2) Data Ingress Node

A Data Ingress Node 330 may define the ingress source for data that is received by a data cleansing pipeline. A Data Ingress Node 330 may come in multiple varieties, including but not limited to an API input node, an import file node, and/or any other node capable of data ingress (e.g., nodes defined in FIG. 10), etc. A Data Ingress Node 330 may prompt a user to set a (for example additional) node input parameter: illustrated as Upload/Download Data File 340 in the figure. A node input parameter may enable the user to for example specify a source (e.g., URL, for example to the path to a remote data file) and/or a local file path (e.g., in a network restricted environment) of data to ingress. In cases wherein more than one data file is available for ingress (e.g., multiple files exist in a single local directory on a user's filesystem), a File Selector 350 may prompt the user for more input 345.

### 3.3) File Selector

In cases where a File Selector 350 pane is opened (e.g., to search a user's network-disconnected local filesystem), a user may be able to select between one or more sources of dirty datasets to be ingressed into a Data Cleansing System 300. Such an operation may implement specific operating system functionality (e.g., opening Windows file explorer, MacOS Finder, etc.). Source dirty datasets may be of CSV, XLSX, XML, JSON, image data, and/or other data formats, etc.

### 3.4) Intermediate Data State Viewer

Data ingressed into a Data Cleansing System 300 may be viewed using an Intermediate Data State Viewer 307. An Intermediate Data State Viewer 307 may display different types of data (e.g., tabular data, image, text information, binary and/or hexadecimal sequences, etc.) in different ways (e.g., using rows & columns, arrays of pictures, and/or line-separated strings of characters, etc.). An Intermediate Data State Viewer 307 may display the intermediate data state of data as it exists at a particular point in a data cleansing pipeline, which may be determined by the node most recently selected by a user. Nodes may be selected by the user for example via a mouse click, finger touch using a touch-enabled device, and/or keyboard input, etc.

### 3.5) Selected Node Data Transformation Viewer

A Selected Node Data Transformation Viewer 309 may display a summary of the one or more data transformations performed by a node most recently selected by the user. Nodes may be selected by a user for example via a mouse click, finger touch using a touch-enabled device, and/or keyboard input, etc. A selected node may be any node present in a data cleansing pipeline. A data transformation summary presented by a Selected Node Data Transformation Viewer 309 may include, but is not limited to, the set of data entries modified by the selected node, the set of anomalous entries discovered by the node, and/or a written description of the function performed by the selected node, etc.

### 4) User Interface/User Experience (Node and Connecting Edge Configuration)

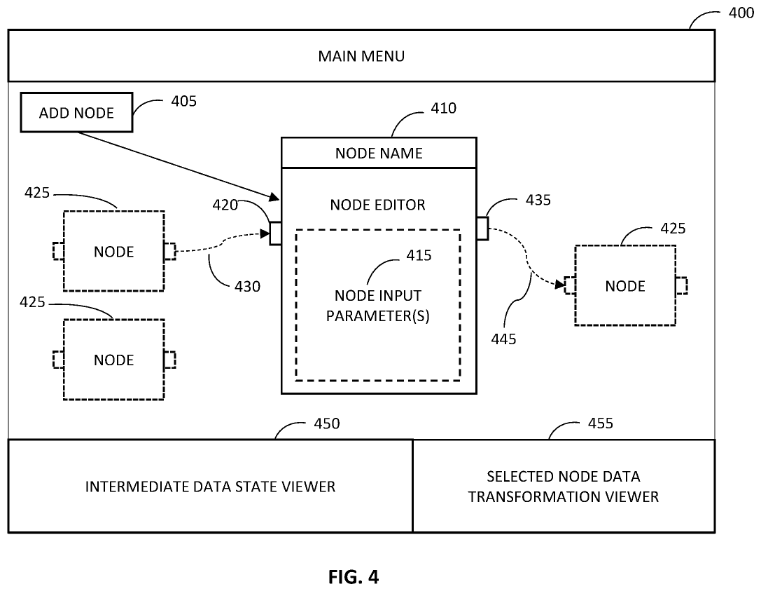

FIG. 4 depicts an example interface of a Data Cleansing System 400 wherein a workspace is shown comprising an Add Node 405 button, Intermediate Data State Viewer 450, Selected Node Data Transformation Viewer 455, and a set of nodes and connecting edges at different levels of abstractions. This example illustrates the process undertaken by a user when adding, configuring, and/or ordering a set of one or nodes and connecting edges, comprising a data cleansing pipeline. The example illustrates how such a process may alter the state of the user interface (e.g., how nodes and connecting edges may be represented graphically within a workspace).

### 4.1) Add Node

A node may be added to the workspace via an Add Node 405 button, as described by FIG. 3, label 320. For the purposes of this example, a user may add any node to a workspace (e.g., any node defined in FIG. 7, FIG. 10, FIG. 11, FIG. 12, FIG. 13, and/or FIG. 14).

### 4.2) Configuring the Node

Once added, a New Node 410 may appear within the workspace, wherein a node is graphically comprised of a node name, node editor section (including zero or more Node Input Parameters 415), zero of more Data Input Ports 420, and/or zero or more Data Output Ports 435, etc. Node Input Parameters 415 may be graphically represented via a user interface by components such as, but not limited to, text boxes, numerical inputs, checkboxes, and/or dropdown menus, etc. Modifications to the Node Input Parameters 415 (e.g., typing values, clicking checkboxes, and/or selecting from dropdown menus), may alter the function of data transformations incorporated into a data cleansing pipeline by an affected node (e.g., matching a different pattern, adding a different number, and/or using a different algorithm, etc.).

### 4.3) Configuring Node Input Ports

The node may comprise zero or more Data Input Port(s) 420. Data Input Port(s) 420 may be chained to Data Output Port(s) 434 of another Node 425 (if it exists) via one or more Connecting Edges 430. Chaining two nodes together in this way (via Connecting Edges 430) may link the data transformations of each together in a sequential manner within a data cleansing pipeline. The output of one Node 425 may become the input for the next Node 425 in the sequence.

### 4.4) Configuring Node Output Ports

The Node may comprise zero or more Data Output Port(s) 435. Each of the Data Output Ports 435 may be chained to the Data Input Port 420 of another Node 425 (if it exists) via zero or more Connecting Edge(s) 445. Chaining (for example two) Nodes 425 together in this way (via a Connecting Edge(s) 445) links the data transformations of each together in a sequential manner within the data cleansing pipeline. The output of one Node 425 may become the input for the next Node 425 in the sequence.

### 5) Rule-Based Data Cleansing and Validation

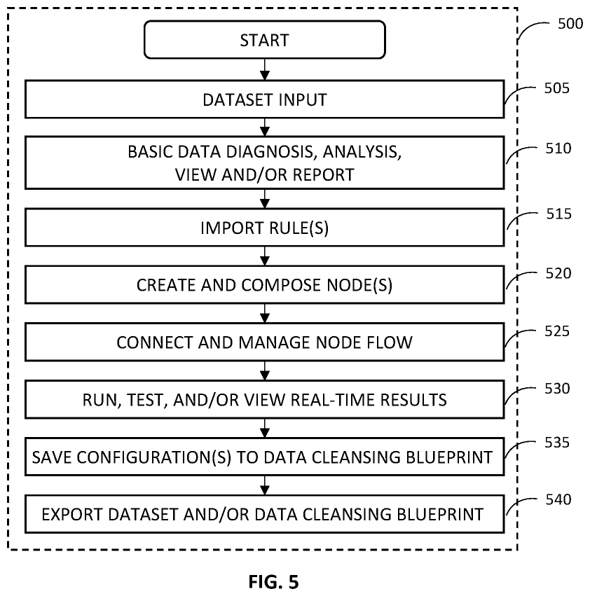

FIG. 5 depicts an example of a Data Cleansing Pipeline 500 in the context of a high-level sequential workflow, wherein a theoretical user creates and uses a Data Cleansing Pipeline 500. This example workflow incorporates both data ingress and data egress, wherein dirty data and/or clean data may enter the system from a starting input, and may exit the system as clean data from a final output. Additional example steps may support the creation and/or usage of a Data Cleansing Pipeline 500, including basic data diagnoses and/or data ruleset import. The creation of a Data Cleansing Pipeline 500 may involve the composition of (for example rules-based) nodes and/or the management of node flow via the inclusion of one or more connecting edges by a user. This process may define a Data Cleansing Pipeline 500 as a dataflow between one or more data transformations. This process may be reordered. It may include other steps not included in this figure and/or steps may be removed in other examples.

### 5.1) Dataset Input

Via Dataset Input 505, data may be ingressed for example from a data storage, a communication, and/or via a user entry through a user interface, etc. Ingressed data may consist of multiple clean and/or dirty datasets and/or may be formatted as tabular data, image data, compressed data, audio data, video data, and/or other data formats, etc. Such data may be stored, via the data storage, persistently, existing between subsequent runs of the program.

### 5.2) Basic Data Diagnosis, Analysis, View, And/or Report

Through Basic Data Diagnosis, Analysis, View and/or Report 510, initial scans of the input dataset may be performed. Such scans may involve, but are not limited to, column categorization (for example as categorical, textual, time-series, numerical, and/or others), outlier detection, and/or AI/ML-based anomaly detection, etc. From such scans, information may be reported via a user-interface to the user. Such reports may include but are not limited to lists of anomalies, lists of outliers, and/or suggestions for certain data-cleansing operations, etc.

### 5.3) Import Rule(s)

Optionally, a user may Import Rule(s) 515 to better guide the basic data diagnoses and/or to create better suggestions for data cleansing operations. Rules may be ingested into the system via for example plaintext, PDF, Word document, JSON, and/or XML, etc. Formats may be parsed, for example via computer vision and/or natural-language processing methods, into unordered lists of basic rules, constituting a data ruleset. Entries in lists may for example include (1) basic restrictions for specific columns in a tabular dataset, and/or (2) rules guiding inter-column relationships, etc. Examples of (1) include but are not limited to restrictions such as a certain column must contain only numbers, a certain column must be of only a certain set of categories, and/or a certain column must never contain a certain substring, etc. Examples of (2) include but are not limited to inter-column relationships such as if a certain column is a number, another column must be text; if a certain column is a certain category, another column must contain a certain type of sentence; and/or if a certain column contains a certain substring, another column must be blank, etc. From the imported set of rules, a set of nodes and/or connecting edges may be automatically produced, wherein this set may perform data cleansing to meet the requirements specified in the imported data ruleset. Rules may be inputted (e.g., typed and/or spoken) into a Data Cleansing Pipeline 500, wherein they may be parsed and/or analyzed using AI/ML to predict and/or generate nodes in a pipeline. Rules may also be imported by receiving one or more examples of dirty dataset(s) and/or clean dataset(s), and may automatically determine the differences and/or steps taken to make that data clean. It may automatically generate one or more Data Cleansing Pipeline 500 that best transform the data from its dirty to clean version(s). This mechanism may have a human-in-the loop step, wherein users may confirm or deny nodes generated. It may evaluate how similar clean data is that is generated by the Data Cleansing Pipeline 500 to the original clean data received. It may have a reinforcement learning mechanism, wherein improvements may be made to automated generation of nodes over time, which may for example be based on user feedback, an evaluation of how similar the clean data provided is to the clean data generated through the generated Data Cleansing Pipeline 500, and/or a combination of approaches, etc.

### 5.4) Create and Compose Node(s)

A user may Create and Compose Rule Node(s) 520 wherein each node may represent a functional block which may perform one or more data transformations in support of enforcing one or more rule in a data ruleset. Each individual node may perform one or more steps of the complete data cleansing process, for example partially remediating dirty data, or remediating it entirely on its own. Nodes may be added to, removed from, and/or edited in a graphical workspace environment. Such nodes implement functionality that includes for example but is not limited to grammar correction, deduplication, mathematical operations, outlier detection, RegEx matching, sentiment analysis, pattern replacement, pattern removal, conditional logic, and/or others. Each node may include zero or more input parameters in addition to its dataset input. A node may prompt for user input, for example should one or more input parameter exist. Parameters may include, for example but not limited to, text inputs accepting patterns to match for, Boolean conditionals related to numeric properties (i.e., greater than a value, less than a value, etc.), dropdown menus selecting a certain category, and/or sliders determining cutoff weights, etc.

### 5.5) Connect and Manage Node Flow

A user may Connect and Manage Node Flow 525 by adding, removing, and/or configuring (e.g., a set of) connecting edges. Connecting edges may for example be drawn on a graphical user interface via dragging the mouse input from the output of one node to the input of another node. The creation of such a connecting edge may create a relationship between the two nodes, sending the data output of one to the data input of the other. In this way, an arbitrarily large set of nodes and their connecting edges may be generated, approximating a data ruleset, and/or enforcing the data rules governed by it on input dirty data. This process may define the node flow, thereby producing a functional and/or repeatable Data Cleansing Pipeline 500.

### 5.6) Run, Test, and View Real-time Results

A user may Run, Test, and/or View Real-Time Results 530 of a Data Cleansing Pipeline 500 by graphically viewing and noting changes to the output dataset as they configure the node flow. Upon making at least one modification to at least one node or connecting edge, the output of a Data Cleansing Pipeline 500 may be altered in real-time: re-processing the algorithm defined by a Data Cleansing Pipeline 500 and/or all its internal data transformations before displaying how a user-made modification altered a Data Cleansing Pipeline's 500 final output. Output may be produced at any node in a Data Cleansing Pipeline 500, displaying the state of the output dataset at that moment in a Data Cleansing Pipeline 500. Data visualization functionality may be implemented to graphically display the output dataset, for example with a bar line, and/or pie chart, etc.

### 5.7) Save Desired Configuration to Blueprint

A user may Save Desired Configuration(s) to Data Cleansing Blueprint 535 for example via a lossless export of the Data Cleansing Pipeline 500 (for example including all its nodes and connecting edges) to a single file on the data storage. This file may be the data cleansing blueprint. The data cleansing blueprint may be reconstructed back into its originating Data Cleansing Pipeline 500, without losing any information (for example any nodes or connecting edges) in the process.

### 5.8) Export Dataset And/or Data Cleansing Blueprint

In Export Dataset and/or Data Cleansing Blueprint 540, a user may (1) egress the output of the Data Cleansing Pipeline 500 (which may consist of clean data) and/or (2) export a data cleansing blueprint via data storage or communication. In (1), a clean dataset may be re-introduced into its originating system, program, or network; remediating any operational issue it may by caused when it was dirty. In (2), a data cleansing blueprint file may be utilized by a headless interpreter in a third-party application, system, or software. In (2), a data cleansing blueprint, via its stored Data Cleansing Pipeline 500, may be re-used to automatically and/or repeatedly cleanse new dirty datasets received as input.

### 6) Data Cleansing Blueprint Production

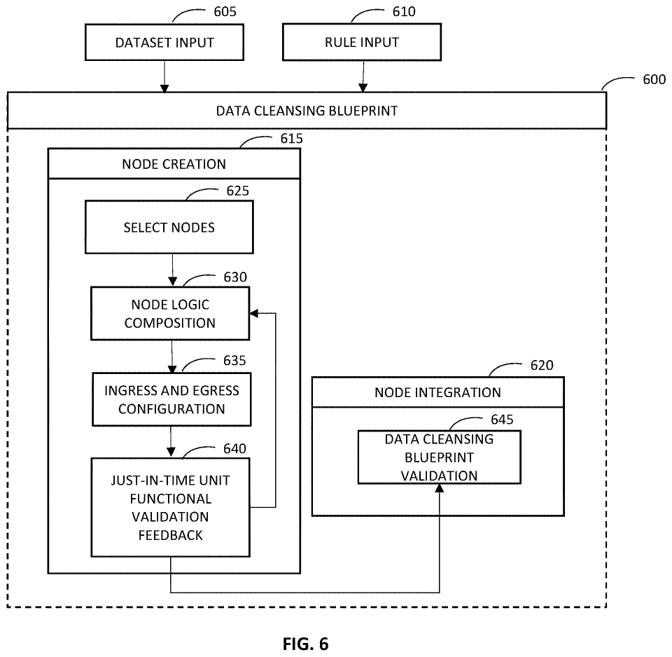

FIG. 6 depicts example steps to create a Data Cleansing Blueprint 600 from a Data Cleansing Pipeline. The features of a final Data Cleansing Blueprint 600 may be determined by the configuration of the nodes in the current pipeline and/or by the data ruleset which the user may have chosen to import. Rules may for example be generated by providing an example clean and dirty dataset, importing a script that performs rules and gets translated to nodes in a Data Cleansing Blueprint 600, importing rules from a pipeline, importing rules from third-party products/tools (e.g., Oracle 9), importing rules stored in XML, JSON, text, domain-specific language (DSL), etc. When a user selects to import a set of rules from a data ruleset during the Rule Input 610 step, rules may be inherited by a final Data Cleansing Blueprint 600 that is produced from the data cleansing pipeline, such that a final Data Cleansing Blueprint 600 conforms to the original rules as well as new ones introduced by configuration of the nodes.

During a Node Creation 615 phase, a final Data Cleansing Blueprint 600 may be updated by each modification made during Node Logic Composition 630. Thereafter, each time the user reconfigures the order of the Select Nodes 625 (which may be a sample of nodes selected for a Data Cleansing Blueprint 600) during the Node Integration 620 process, a final Data Cleansing Blueprint 600 may be updated again. Data Cleansing Blueprint(s) 600 may be validated through a Data Cleansing Blueprint Validation step in a Node Integration 645 process, wherein the full resulting Data Cleansing Blueprint 600 may be validated (e.g., ensuring each node works as expected through sample data). Node Creation 615 may include Ingress and Egress Configuration 635, which may define the accepted inputs and outputs for each node, and/or include Just-in-Time Unit Functional Validation Feedback 640, which may calculate real-time feedback of example inputs and outputs of each node. A product of a data cleansing pipeline may be the resulting data that was transformed by the configured nodes, as well as a Data Cleansing Blueprint 600, which may be reused across other third-party applications, software, and/or programming languages, etc.

An example usage of Data Cleansing Blueprint 600 import and/or augmentation may be illustrated in a scenario of medical data for child patients. In such an example, an imported Data Cleansing Blueprint 600 may contain a set of rules that may apply to all patients. These rules may state that patient age cannot be greater than 122 years old (the oldest age ever recorded), however, since the final Data Cleansing Blueprint 600 pertains to children, the modified Data Cleansing Blueprint 600 may state that the oldest age allowed in the dataset is 17 years old. An example pertaining to medical data may be the import and/or application of a Data Cleansing Blueprint 600 which would enforce that the data adheres to legal and/or ethical regulations for proper storage of patient data as defined by HIPAA (Health Insurance Portability and Accountability Act). This process may be reordered. It may include other steps not included in this figure and/or steps may be removed in other examples.

### 7) User Interface/User Experience (Node Category Selection)

FIG. 7 depicts an example interface for a Node Category Selection Menu 700, wherein a user can may select between different categories of nodes to add to their workspace. Node Categories 710 may contain several categories that may be useful in a data cleansing pipeline, including but not limited to for example I/O Nodes 720, AI/ML Nodes 735, Boolean Nodes 725, General Nodes 740, and/or Data Visualization Nodes 730, etc.

### 7.1) Modules

Using Modules 745, users may import, select, and/or utilize previously configured custom data cleansing pipelines and/or sequences of nodes as if they are a single node in the data cleansing pipeline. This function may allow the user to create node sequences which may be reused and/or repurposed across multiple data cleansing pipelines. This may allow for consolidation of large and/or complex pipelines. It may enable a user to save time which would be spent recreating a node flow that they have already configured prior. Modules may be generated and/or saved by a user as they see fit. Adding a custom module to a data cleansing pipeline works similarly to adding a node. It may be done by clicking Add Node 705 but may assume that the user has already saved a separate data cleansing pipeline as a module. A module may begin by receiving input, so that it may be incorporated into the current node flow. Modules may produce output(s) that feed back into a data cleansing pipeline, and/or they may not produce exportable output, such as (but not limited to) visualization(s), API endpoint(s), and/or a graphical user interface, etc. The module option may allow for function-like incorporation of pipelines within other pipelines (such as how functions work in many popular programming languages).

An example usage of Modules 745 can be explained using computer vision data, where the same processes may be repeated on the data for nearly every computer vision task. In computer vision, there may be a common set of steps to perform in order to prepare the visual data for AI/ML processing. Some of the common and possible example steps taken on image data (which is described in a data matrix of pixel values) may be resizing and cropping, normalization of the pixel values, augmentation (such as applying for example rotation, flipping, zooming, contrasting, and/or brightening, etc.), noise reduction, filtering, and/or translation to another color space (RGB to grayscale is a common example). Such tasks may have general processes that repeat similar steps no matter what visual data is being manipulated. For example, a filter that applies gaussian blur is a generic matrix operation on a set of pixel values, and/or the operation may be created as a module and/or used again in future computer vision data cleansing pipelines.

### 8) Real-Time NLCP Unit Functional Validation Feedback Loop

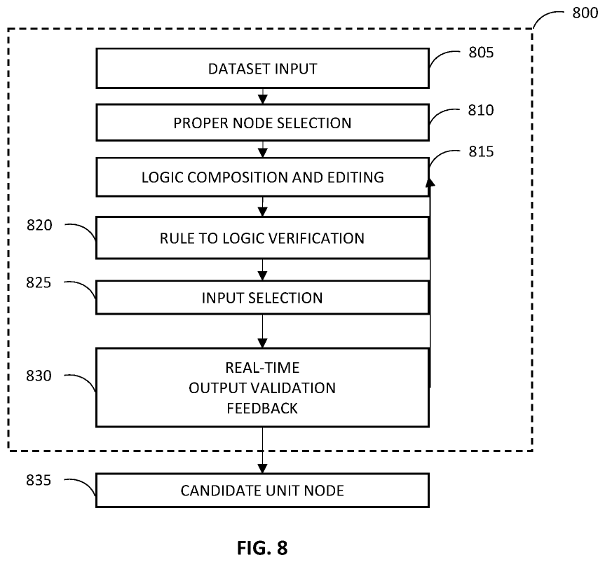

FIG. 8 describes an example (e.g., used in the Data Cleansing System) for Real-Time Unit Functional Validation Feedback Loop 800, in which there may be steps for composing a node unit to achieve a desired functionality to process the data to yield desired output. This may be for a single node unit which implements the modularity concept in a node.

### 8.1) Dataset Input

Dataset Input 805 may constitute the data source of this node, and may for example be the only source. This may be the data stream from a file, such as a CSV file, and/or a data stream input from another node, etc.

### 8.2) Proper Node Module Selection

To process data to achieve a desired output, there may be a menu of groups of nodes for users to select a proper node (Proper Node Selection 810) with desired functions to process the data. For example, a user may want to sort a column on the dataset, and the menu labeled with a general block may be clicked to display the grouped functional nodes in which the desired node can be selected.

### 8.3) Logic Composition and Editing

A user may set the operation parameters to desired values via Logic Composition and Editing 815 (for example once the desired node is selected and/or if the node requires logic operation settings). For example, if logic node AND is selected, users may configure data to AND with 0, 1, 0xFF00, etc.

### 8.4) Rule to Logic Verification

The Rule to Logic Verification 820 step may determine that the logic nodes generated function properly, for example by running test cases against the nodes, and/or ensuring rules do not interact in ways that are not possible.

### 8.4) Input Selection

Input selection 825 may allow users to specifically select which input (for example column(s) from the dataset to be processed). For example, a user may want to configure a logical AND on column labeled “F” on the dataset, by selecting or typing in the label “F” in the selection field for the node to select column “F” only.

### 8.5) Real-Time Output Validation Feedback

A user may view results (for example once the user has executed the node to process the data) output of the node Real-Time Output Validation Feedback 830, which is for example displayed on a screen in real-time. If the output result is not what the user expected, the user can go back to step Logic Composition and Editing 815 to modify the node(s) until the expected result is obtained. This feedback loop allows the users to test, validate, and/or fine-tune the functionality feature of the node. Using the previous logical AND example, if the resulting data after AND operation are not expected, the user may modify value 0xFF00 to something different and continue testing until the result meet the user's requirements.

### 8.6) Candidate Unit Node

A Candidate Unit Node 835 is the resulting node which may perform a specific and/or desired data processing task that the user validated and/or finalized.

### 9) Real-Time System Functional Validation Feedback Loop

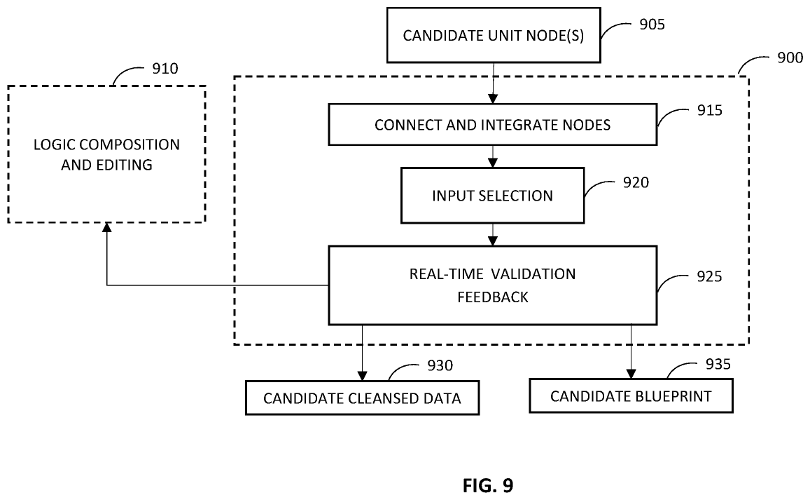

FIG. 9 illustrates an example (e.g., used in the data cleansing system) for Real-time System Functional Validation Feedback Loop 900, in which there may be steps to integrate various unit nodes (for example created as illustrated in FIG. 8) to process data to yield desired cleansing output. The result of this step may not only yield the cleansed data but may yield a data cleansing blueprint.

### 9.1) Connect and Integrate Nodes

The user may Connect and Integrate Nodes 915 to process the data with zero or more Candidate Unit Node(s) 905 with steps for example in a sequential order. Each node may for example have a node input port and/or a node output port to connect to. For example, the user may connect the output port of the AND node to the input port of the SORT node, so that data may be processed by AND node first, then processed by the SORT node.

### 9.2) Input Selection

Input Selection 920 may allow users to select which column(s) from an input dataset to be processed. For example, a user may want to do a logical OR on column labeled “A” on the dataset, so users may select and/or type in the label “A” in the selection field for the node to select column “A” only.

### 9.3) Real-Time Output Validation Feedback

Once the user executes the connected node to process the data, the user may view the results on a screen in real-time, which is Real-Time Validation Feedback 925. If the output result is not what the user expected, the user may do Logic Composition and Editing 910 to modify the node(s) until the expected result is obtained. This feedback loop allows the users for example to test, validate, and/or fine-tune the functionality feature of the connected node. The viewing of the result data may be on a screen and/or utilize a processed data viewer. Referring to the previous logical AND with SORT node example, if the resulting data after SORT operation is not expected, the user may modify value 0xFF00 on the AND node and/or modify the parameter of the SORT node to something different to test until satisfied.

### 9.4) Candidate Cleansing Data

Candidate Cleansed Data 930 may be the resulting dataset when data is cleansed, for example in line with a user's expectations. It may be exported at any step in the data cleansing process at any node. It may include one or more cleansed dataset. It may be cleansed and/or available for export continuously, one-time, daily, weekly, seasonal, etc.

### 9.5) Candidate Blueprint

Candidate Blueprint 935 may be the resulting connected nodes, with configured parameters, and executing flow when data is cleansed to expected result. It may include one or more candidate blueprints. It may be cleansed and/or available for export continuously, one-time, daily, weekly, seasonal, etc.

### 10) I/O Nodes

FIG. 10 depicts an example I/O Nodes Selection Menu 1000 from which one or more exemplary nodes may be added to the data cleansing pipeline. Nodes may be part of the I/O category if they implement functionalities involving data ingress and/or egress. Such functionalities may include, but are not limited to, importing data from a file, ingressing data from an API, exporting data to a file, and/or egressing data via an API, etc. Data ingressed and/or egressed using an I/O node may support, but is not limited to, the CSV, XLSX, TXT, JPEG, PNG, MP4, and/or MP3 formats, etc. Examples of nodes include but are not limited to:

### 10.1) API Input Node

An API Input 1005 node may be used to ingress dirty dataset(s) into the data cleansing system for example from an external system, application, and/or computer program (e.g., script, program, etc.), etc. The source (e.g., system, application, and/or computer program) may be specified by the user through a (for example additional) node input parameter. A node input parameter may enable the user to specify a source (e.g., URL, for example to the path to a remote data file). An example usage of the API Input 1005 node includes but is not limited to the ingress of legacy medical data from a database located in a hospital, wherein both the medical data database the data cleansing system are hosted on the hospital's local computer network. In such an example, private and/or personal medical data may be cleansed by the data cleansing system without threat of data-leaks and/or legal issues, etc.

### 10.2) API Output Node

An API Output 1010 node may be used to egress clean dataset(s), and/or data cleansing blueprint(s), from the data cleansing system for example to an external system, application, and/or computer programs (e.g., script, program, etc.), etc. The target (e.g., system, application, and/or computer program) may be specified by the user through a (for example additional) node input parameter. This node input parameter may enable the user to specify a target (e.g., URL, for example to the path to a remote data destination). An example usage of the API Output 1010 node includes but is not limited to the egress of cybersecurity log data to an organization's SIEM (Security Information and Event Management) system, etc. In such an example, the data cleansing system may cleanse the egressed cybersecurity log data into a format acceptable by the SIEM, preventing any issue which may have arisen due to non-standardization. This may prevent the SIEM from crashing, and/or prevent the SIEM from being unable to display the cybersecurity log data properly, etc.

### 10.3) Export File Node

An Export File 1015 node may be used to egress clean dataset(s) and/or data cleansing blueprint(s), from the data cleansing system for example to the user's local filesystem via a file dump and/or file download, etc. The target location on the user's local filesystem may be specified by the user through a (for example additional) node input parameter. An example usage of the Export File 1015 node includes but is not limited to the egress of clean commercial transaction data from the data cleansing system in a network restricted environment, such as but not limited to a store, marketplace, or other place of business. In such an example, anomalous commercial transaction data such as an over-billed client invoice and/or incorrect product/purchase-order relationship would be detected and cleansed, preventing financial loss for the organization using the data cleansing system. File types may include but are not limited to local files with formats (e.g., CSV, TXT, PNG, MOV, and/or XLSX, etc.).

### 10.4) Import File Node

The Import File 1015 node may be used to ingress dirty dataset(s) for example from the user's local filesystem to the data cleansing system, for example via a file drop and/or file upload. The source location on the user's local filesystem may be specified by the user through a (for example additional) node input parameter. An example usage of the Import File 1015 node includes but is not limited to the ingress of dirty maintenance data into the data cleansing system in a network-restricted environment, such as but not limited to a warehouse, distribution center, and/or auto-shop, etc. In such an example, anomalous maintenance data such as manhour outliers and/or incorrectly labeled schematics may be detected and cleansed, preventing production downtime and/or reducing redundant time spent on maintenance activities. File types may include but are not limited to local files with formats (e.g., CSV, TXT, XLSX, JPEG, MP4, and/or MP3, etc.). Examples of nodes include but are not limited to:

### 11) Boolean Nodes

FIG. 11 depicts an example Boolean Nodes Selection Menu 1100 from which one or more exemplary nodes may be added to the data cleansing pipeline. Nodes are a part of the Boolean category if they perform logical Boolean operations to filter or select subsets of an input dataset (e.g., selecting or filtering for a subset of rows in a tabular dataset). Boolean may be used in conjunction with one or more select nodes. Subsets of data selected by one or more select nodes may be combined, modified, and/or filtered following logical operations, as specified by the series of Boolean nodes added to a data cleansing pipeline.

### 11.1) AND Node

An AND Node 1105 may be used to perform a logical AND operation on two selected subsets of data: A∧B. An AND Node 1105 may have two data input ports, one for A and one for B. An AND Node 1105 enforces that both data input ports refer to the same dataset; however, the subset of selected rows in A may be different than those selected in B. When an example AND Node 1105 is used in conjunction with tabular data, A and B can be thought of as being the same dataset but having different subsets of selected rows. In the case of tabular data, the output of an AND Node 1105 is A∧B: the subset of rows that is selected in both A and B. For example, if A selects for rows {1, 2, 3}; and B selects for rows {3, 4, 5}; A∧B is {3}. An example usage of an AND Node 1105 includes but is not limited to instances of tabular maintenance data wherein a dataset contains a column for maintenance type and/or another column for maintenance description. In this case, dirty data may be produced via human error, wherein a maintenance operator assigns the incorrect maintenance type for the maintenance task they described in the maintenance description. The AND Node 1105 may be used to detect instances such as these, where maintenance type AND maintenance description disagree (e.g., the human operator states that they only performed an inspection in the maintenance type column but writes that a repair took place in the maintenance description). In such an example, a data cleansing system may detect and/or remediate such labeling issues, preventing production downtime and/or reducing redundant time spent on maintenance activities.

### 11.2) OR Node

An OR Node 1110 may be used to perform a logical OR operation on two selected subsets of data: A∨B. An OR Node 1110 may have two data input ports, one for A and one for B. The OR Node 1110 enforces that both data input ports refer to the same dataset; however, the subset of selected rows in A may be different than those selected in B. When an example OR Node 1110 is used in conjunction with tabular data, A and B may be thought of as being the same dataset but having different subsets of selected rows. In the case of tabular data, the output of an OR Node 1110 is A∨B: the subset of rows that is selected in either A or B. For example, if A selects for rows {1, 2, 3}; and B selects for rows {3, 4, 5}; A∨B is {1, 2, 3, 4, 5}. An example usage of an OR Node 1110 includes but is not limited to instances of tabular medical data wherein a dataset contains a column for patient blood type and another column for prescribed drug. In this example, dirty data may be produced via human error, wherein a healthcare professional prescribes the incorrect prescribed drug for a certain patient blood type. An OR Node 1110 may be used to detect instances such as these, where for a given patient blood type, only one prescribed drug OR a second prescribed drug is effective (e.g., for patient blood type O only two types of medication are effective). In such an example, a data cleansing system would detect and remediate these issues, preventing the prescription of an ineffective drug and/or preventing unwanted medical side effects.

### 11.3) NOT Node

A NOT Node 1115 may be used to perform a logical NOT operator on a selected subset of data: ¬A. A NOT Node 1115 may have one data input port: A. When used in conjunction with tabular data, this data input port may reference a dataset with one or more selected rows. In this case, the output of a NOT Node 1115 is ¬A: the subset of rows in A that are not selected. For example, if A selects for rows {1, 2, 3}; and A has 5 rows total; then ¬A is {4, 5}. An example usage of a NOT Node 1115 includes but is not limited to instances of tabular commercial transaction data wherein a dataset may contain a column for product and anther column for price. A particular product is known to always be sold at the same price (e.g., a vacuum cleaner for $200.00), although some other products may have been sold at anomalous and/or improperly formatted prices. A NOT Node 1115 may be used to filter out all entries of this uninteresting product, improving the performance time of the data cleansing pipeline as it operates on all other products.

### 12) Visualization Nodes

FIG. 12 depicts a Visualization Nodes Selection Menu 1200 from which one or more example nodes may be added to a data cleansing pipeline. Nodes may be part of the visualization category if they (1) perform data visualization and/or (2) perform a documentation-focused, secondary purpose that does not add any additional data transformations to the data cleansing pipeline, etc. Examples of nodes include but are not limited to:

### 12.1) Chart Node

A Chart Node 1205 may be used to visualize data by representing an input dataset using for example one of, but not limited to, the following charts: a bar chart, a line chart, and/or pie chart, etc. A user may select the specific kind of chart to display by configuring a (for example additional) node input parameter, wherein a dropdown menu enables a user to select between one of the previous chart options. In an exemplary case of tabular data, two additional node input parameters may be made available for a user to configure: (1) column selection for the X axis and (2) column selection for the Y axis. In the case of (1), a user may select a column of the dataset that may be used for the X axis in the bar and line charts, or the categories of the pie chart. In the example, a column used for the X axis contains categorical or textual values. In the case of (2), a user may select a column of the dataset that may be used for the Y axis in the bar and line charts, or as the proportions of the pie chart. In the example, the column used for the Y axis contains numeric values. An example usage of a Chart Node 1205 includes but is not limited to charting financial information present in commercial transaction data to spot trends and/or anomalies, etc. In such an example, dirty data may be discovered by a human observer, enabling them to report upon, remediate, and/or reconfigure a new or existing data cleansing pipeline. This may prevent financial loss for the organization and/or individual using the data cleansing system.

### 12.2) Comment Node

A Comment Node 1210 may for example be used to append notes, attach documentation, and/or link external information sources to a data cleansing pipeline, etc. The node may present a text field as a (for example additional) node input parameter. This text field may be modified at will by the user, persisting any appended notes, attached documentation, and/or linked sources between runs of the data cleansing pipeline; and/or between exports and/or imports of a data cleansing blueprint, etc. The node itself does not perform any data transformations within the data cleansing pipeline it is incorporated into. An example usage of a Comment Node 1210 includes but is not limited to documenting a data cleansing pipeline that is used to cleanse computer vision system data. Such a data cleansing pipeline would consist of multiple stages, many nodes, and many connecting edges. Comment Nodes 1210 may be present to explain the function of each stage of such a data cleansing pipeline. Future maintainers of this data cleansing pipeline may, due to an abundance of well-documented components, save time and/or costs that would potentially be instead spent manually cleansing computer vision system data.

### 12.3) Correlation Matrix Node

A Correlation Matrix Node 1215 may be used to create and display a table which visually may present the correlation coefficients for different variables in an input dataset (e.g., each column in a tabular dataset). A correlation coefficient in this case refers to a statistical measure of strength of the linear relationship between pairs of variables. For example, two separate variables, one representing the hours a student spends studying, and the other representing the score the student receives on a test, may have a high correlation coefficient because the two variables are heavily related. Two separate variables, one representing the hours a student spends studying, and the other representing the student's height, may have a low correlation coefficient because the two variables are unrelated. An example usage of a Correlation Matrix Node 1215 includes but is not limited to reporting the correlation coefficients in data used for prediction or classification tasks by a machine learning model to the user. In such an example, a user would gain valuable insight into the statistical properties of their dataset; with such insight being used to determine the appropriate machine learning methods to apply to the user's classification task (e.g., linear regression, Naïve Bayes, etc.). This would save time and/or costs associated with manual statistical analysis.

### 13) AL/ML Nodes

FIG. 13 depicts an example AI/ML Node Selection Menu 1300 from which one or more example nodes may be added to the data cleansing pipeline. Nodes may be part of the AI/ML category if they perform AI/ML based analysis or data transformation including but not limited to statistical modeling, sentiment analysis, classification, and/or other neural network-based operations, etc. Examples of nodes include but are not limited to:

### 13.1) Custom ML Node

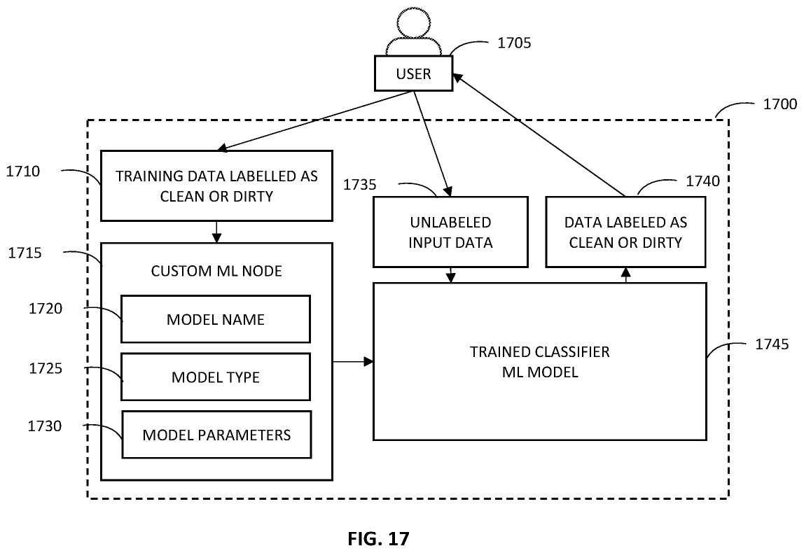

A Custom ML Node 1305, when added to a data cleansing pipeline enables the user to create, train, retrain, and fine-tune machine learning models (for example classifier models or any other machine learning models) for the purposes of data cleansing. The user specifies the type of model, model name, and/or other input parameters required by the model (number of training epochs, and/or train/test split, etc.) as node input parameters. The user may for example provide a custom ML node with tabular training data. This training data may for example consist of rows labelled as “clean” or “dirty”. A ML model may be trained on this dataset and becomes indexable for later use in the data cleansing pipeline. How the user interacts with the custom ML node is summarized in FIG. 17. An example usage of a Custom ML Node 1305 includes, but is not limited, to training a machine learning model to identify bad formatting present in cybersecurity log data. Such a machine learning model could be trained to identify problems specific to the format of the user's cybersecurity log data, filtering out problematic logs and preventing network monitoring downtime or log data corruption (for example, such problematic log entries may be corrected subsequently, for example in the same data cleansing pipeline).

### 13.2) Similarity Node

A Similarity Node 1310, when added to a data cleansing pipeline enables the similarity (i.e., data proximity) of two or more data entries to be determined. A Similarity Node 1310 may for example utilize various machine learning methods including but not limited to for example tokenization, cosine similarity, and natural language processing. The user may provide a “base-sentence” as a (for example additional) node input parameter. This “base-sentence” may be compared against multiple data-entries, with each comparison resulting in a floating-point value between the numbers of 0 and 1; 0 may indicate no similarity, 1 may indicate full similarity. Data entries which produce a high enough similarity value may be selected as candidates for later data cleansing. An example usage of a Similarity Node 1310 includes but is not limited to removing sufficiently similar images and/or entries in computer vision system data, etc. Such images and/or entries may cause bias in computer vision ML systems trained on such data. Therefore, removing sufficiently similar image entries may decrease the degree of false positives and/or false negatives that occur in image classification, object detection, and/or sematic segmentation computer vision tasks, etc.

### 13.3) Grammar Node

A Grammar Node 1315, when added to a data cleansing pipeline enables grammatical errors in dirty data to be discovered, deleted, and/or remediated, etc. A Grammar Node 1315 may utilize various machine learning methods including but not limited to NLP-based text-classification and tokenization. Data entries may be assigned a label of for example “Acceptable” or “Unacceptable” by the Grammar Node 1315. “Unacceptable” entries may be selected as candidates for later data cleansing. An example usage of a Grammar Node 1315 includes but is not limited to the discovery of grammatical errors in medical data. Such errors may include the misspelling of prescription drugs and/or the of common biological terminology. By discovering and remediating dirty data of this kind, a legacy medical data system may become less prone to legal dispute and/or become more easily query-able by common search terms, etc.

### 13.4) Sentiment Node

A Sentiment Node 1320, when added to the data cleansing pipeline enables sentiment analysis to be performed on input data entries. A Sentiment Node 1320 may utilize various machine learning methods including but not limited to probabilistic classification, transformer networks, and tokenization. Data entries may be assigned a label of for example “Negative”, “Neutral”, and/or “Positive” based upon determined author sentiment. Entries assigned any of the labels may be selected as candidates for later data cleansing, with the specific label being chosen via a (for example additional) node input parameter provided by the user. An example usage of the Sentiment Node 1320 may include but is not limited to the cleansing of commercial transaction data to identify and remove inflammatory, insincere, and/or otherwise non-serious product reviews. This may prevent an individual and/or organization from making important financial decisions based upon inaccurate information.

### 14) General Nodes

FIG. 14 depicts an example General Node Selection Menu 1400 from which one or more nodes may be added to a data cleansing pipeline. Nodes may for example be part of the general category if they perform basic data transformations including but not limited to data removal, data replacement, and/or data selection, etc. Examples of nodes include but are not limited to:

### 14.1) Deduplicate Node

A Deduplicate Node 1405, when added to a data cleansing pipeline may enable the deduplication, deletion, and/or replacement of duplicate entries in a dirty dataset, etc. What constitutes a duplicate entry may be defined as a (for example additional) node input parameter by the user, usually involving the number of identical columns shared between two rows of tabular data, and/or other methods for other non-tabular datatypes. An example usage of a Deduplicate Node 1405 includes but is not limited to removing duplicate or images and/or entries in computer vision system data. Such images and/or entries may cause bias in computer vision ML systems trained on such data. Therefore, removing duplicate image entries would decrease the degree of false positives and/or false negatives that occur in image classification, object detection, and/or sematic segmentation computer vision tasks, etc.

### 14.2) Outliers Node

An Outliers Node 1410, when added to a data cleansing pipeline may enable the discovery, deletion, and/or replacement of outlier entries in a dirty dataset, etc. Outlier discovery may consist of two steps: (1) determining the type of data and (2) determining outliers based on that type of data. In (1), data may be broken into types including but not limited to categorical data, numerical data, textual data, and/or time series data. In (2), different outlier-detection methods may be used for each type of data. For categorical data, all possible valid categories may be first determined. Data entries which do not fall into one of these categories may be determined to be outliers. For numerical data, numeric entries that fall outside of some numbers of standard deviations maybe determined to be outliers. The exact number of standard deviations may be defined as a (for example additional) node input parameter by the user. For textual data, AI/ML algorithms such as isolation forest, Euclidean distance, and/or robust random cut forest, etc. may be used to determine non-similar textual outliers. For time series data, the most common datetime format that is prevalent in the data is first determined; including but not limited to Unix time, ISO 8601, or MM/DD/YYYY etc. Entries which may not be of this common format, as well as entries which fall outside of some number of standard deviations, may be determined to be outliers. An example usage of an Outliers Node 1410 includes but is not limited to detecting and cleansing anomalous manhour entries in maintenance data, wherein human error introduces a radically large or smaller data entry into the dataset. Remediating such instances may produce a more accurate picture of an organization's and/or individual's work schedule and/or reduce redundant time spent on maintenance activities.

### 14.3) Select Node

A Select Node 1415, when added to a data cleansing pipeline enables the identification and selection of specific entries in a dirty dataset for later cleansing. The selection strategy of the select node may be determined by the user as a (for example additional) node input parameter. Selection strategies include but are not limited to selecting for example empty and/or blank entries, equality checking, substring matching, RegEx pattern matching, data-type matching, entry length selection, and/or numeric comparison, etc. A selection strategy may involve the inclusion of additional node input parameters as provided by the user. For example, RegEx pattern matching may require an input regular expression, entry length selection requires a length to compare against, and/or substring matching requires an input substring. Selected entries may be highlighted; this highlighting information is passed along as input to subsequent nodes in the data cleansing pipeline. An example usage of a Select Node 1415 includes but is not limited to using RegEx pattern matching to discover, report, and/or remediate malformed IP addresses in cybersecurity log data. This may prevent malicious activity from going unnoticed by an individual and/or an organization, ultimately protecting from denial-of-service attacks, SQL injection, and/or other common network attacks.

### 14.4) Time Node

A Time Node 1420, when added to a data cleansing pipeline may enable the normalization of all datetime-based data entries into a standard format. This standard format may be determined by a user as a (for example additional) node input parameter. Example standard formats include but are not limited to Unix time, ISO 8601, and/or MM/DD/YYYY, etc. An example usage of a Time Node 1420 includes but is not limited to standardizing legacy medical data wherein patient date-of-birth is in a non-consistent or no-longer-supported format. This may enable legacy data to be cleansed and migrated to a modern system, equipping consumers of the medical data with enhanced capabilities (e.g., a modern query system, and/or caching and faster I/O, better network policy configuration, etc.), etc.

### 14.5) Math Node

A Math Node 1425, when added to a data cleansing pipeline may enable various mathematical operations to be performed on numeric datatypes. Such operations include for example but are not limited to addition, subtraction, multiplication, division and/or rounding, etc. A specific operation may be determined by a user as a node input parameter. An example usage of a Math Node 1425 includes but is not limited to standardizing currency into a common unit of value within commercial transactions data according to current foreign exchange rates. This may enable an individual and/or organization to create and maintain professional and/or commercial relationships with foreign entities.

### 14.6) Remove Node

A Remove Node 1430, when added to a data cleansing pipeline may enable the removal of selected data entries in a dirty dataset; in tabular data, this may involve the removal of selected rows and/or columns. Data entries may be selected for removal by a select node and/or as a (for example additional) node input parameter provided by the user. An example usage of a Remove Node 1430 includes but is not limited to removing blank, null, empty, and/or otherwise meaningless entries in data used for prediction or classification tasks by a machine learning model, etc. Removing such entries may decrease the degree of false positives and/or false negatives that occur in prediction and/or classification tasks, ultimately resulting in an ML model with less unwanted bias.

### 14.7) Sort Node

A Sort Node 1435, when added to a data cleansing pipeline may enable data to be sorted according to a certain sorting scheme. In the case of tabular data, data may be sorted by a specific column as determined by a (for example additional) node input parameter provided by a user. Sorting schemes include for example but are not limited to sorting alphabetically, sorting in numerical order, and/or sorting by datetime, etc. Sorting order may for example also be reversed as prompted by the inclusion of a (for example additional) node input parameter provided by the user. An example usage of a Sort Node 1435 includes but is not limited to sorting cybersecurity log data by user session length to identify abnormally long and/or short sessions. Identification of such sessions may indicate invalid/inapplicable logs and/or malicious network activity.

### 14.8) Transpose Node

A Transpose Node 1440, when added to a data cleansing pipeline may transpose a tabular dataset across its diagonal, swapping the dataset's rows and columns. An example usage of a Transpose Node 1440 includes but is not limited to mitigating issues from improperly exported data; wherein for example either human or software error resulted tabular data being flipped across its diagonal undesirably (e.g., from Microsoft Excel export, and/or MySQL dump, etc.). This potentially may save an individual and/or organization time and/or costs that would be required to manually fix such a formatting error.

### 14.9) Merge Node

A Merge Node 1445, when added to a data cleansing pipeline may enable two or more input datasets to be merged into a single dataset. The user may provide additional node input parameters to determine factors such as for example but not limited to the order of dataset concatenation and trimming to fit a larger dataset to a smaller one. An example usage of a Merge Node 1445 includes but is not limited to merging multiple sources of medical data together from disparate sources across a hospital's local computer network. Such sources may be aggregated into a single dataset, standardized to a common format. This may enable legacy data to be migrated to a modern system, equipping consumers of the medical data with enhanced capabilities (e.g., a modern query system, caching and faster I/O, and/or better network policy configuration, etc.).

### 14.10) Replace Node

A Replace Node 1450, when added to a data cleansing pipeline may enable selected data entries to be replaced by a certain value as defined by a (for example additional) node input parameter provided by the user. Data selection may for example involve but is not limited to RegEx matching, substring matching and/or selection via a Select Node 1415. An example usage of a Replace Node 1450 includes but is not limited to squashing a divergent set of warning labels into a common set in cybersecurity log data. For example, log warning labels produced by disparate tools may have different words for the same concept (e.g., “RED”, “URGENT”, and/or “CRITICAL” may reflect a log that demands the highest amount of administrator attention). Disparate labels may be replaced with a common/unified label (e.g., “RED”, “URGENT”, and “CRITICAL” all become “CRITICAL”).

### 14.11) Split Node

A Split Node 1455, when added to a data cleansing pipeline may enable a single input dataset to be split into two or more output dataset. Parameters relevant to the splitting process may be provided as additional node input parameters by the user. Such parameters include for example but are not limited to the cutoff for the split and/or the number of output datasets. An example usage of the Split Node 1455 includes but is not limited to producing a train/test split for data used for prediction or classification tasks by a machine learning model. This may enable users to train and test ML models on the same dataset, without having to spend the time and/or costs to manually split the dataset.

### 15) Customizable AI/ML Node

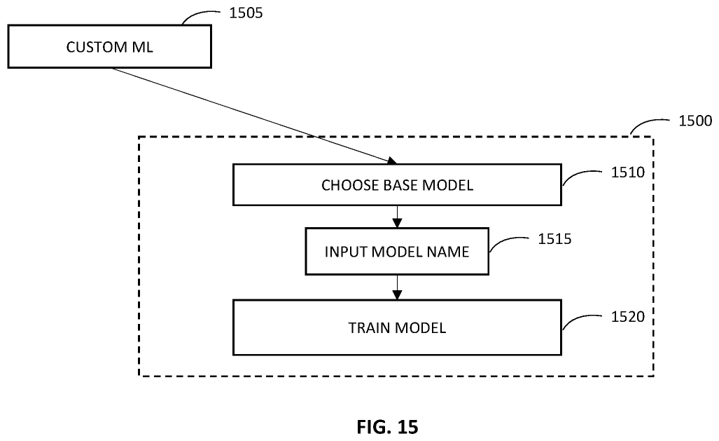

FIG. 15 depicts an example configuration interface for a Custom AI/ML Model Node 1500. This node may allow a user to select and/or configure a common ML model, and/or fine-tune the parameters to meet their needs. The user then may train the model on their own custom data set and/or fine-tune it even further.

A user may begin by Choosing a Base ML Model 1510. Example base models include but are not limited to multi-layer perceptron, logistic regression, Naïve Bayes, and/or k-nearest neighbors, deep neural nets, large language models, convolutional neural networks etc. After selecting their base model, the user may Input the Model Name 1515 for their new model. This may allow the user to identify the Custom ML 1505 model and/or reuse it later and/or in other workspaces.

The user may select the fine-tune parameters of their model where Train Model 1520 is displayed. Models and/or model-templates adhere to pre-existing models and/or offer tools for executing common machine-learning techniques.

An example application of a Custom AI/ML Model Node 1500 would be in a fraud detection scenario for commercial transaction data. A bank, for example, may want to create a custom logistic regression node to determine the likelihood that a set of transactions constitute fraudulent activity. In such an example, the bank may select the features for the model that should be considered in making a determination about fraud, such as amount transacted, frequency of transaction, transaction destination, and/or deviation in spending pattern (such as unlikely purchase location or merchant). Furthermore, the bank may decide that a certain degree of the formerly mentioned features may be acceptable and may then modify the threshold for classification (of fraud). In this example, use of the Custom AI/ML Model Node 1500 would be beneficial for the bank, and such a node may be reused again in the future for similar operations.

### 16) AI/ML Data Training

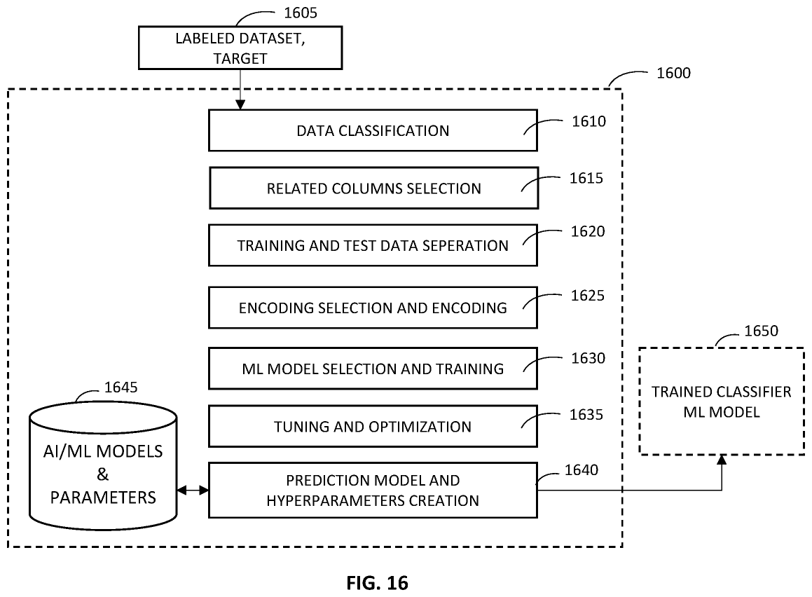

FIG. 16 depicts an example function for AI/ML training for the Custom AI/ML Model Node 1600. A Custom AI/ML Model Node 1600 may be used to produce (partially or fully) trained classifier ML models. Trained Classifier ML Models may be used within a data cleansing pipeline to perform classification, prediction, generation and/or other ML-related tasks, etc. Depending on the training (e.g., what kind of data it was trained on, and how that data was labeled), its function may differ.

### 16.1 Labeled Dataset, Target

A user may provide a Labeled Dataset, Target 1605 to the training function. This dataset may for example contain data entries labeled as either “Clean” or “Dirty”. This dataset may be sourced from for example one of, but not limited to, the following: real-world data gathering, online resources (e.g., Kaggle), and/or synthetic data generation, etc. In the case of synthetic data generation, the data cleansing system itself may be used to generate mock, synthetic data (e.g., via a specialized data cleansing pipeline with the goal of generating synthetic data for the purposes of AI/ML model training).

### 16.2 Data Classification

A Data Classification 1610 function may classify the input training set into one or more datatypes, for example but not limited to: numerical data, categorical data, image data, text data, time series data, audio data, sensor data, and/or structured data, etc. Datatype(s) selected may modify downstream processes (e.g., encoding type, and/or optimization metric, etc.).

### 16.3 Related Columns Selection

A Related Columns Selection 1615 function may enable the user to select correlated columns, and/or the columns which should be tied together in determination of the predicted datatype.

### 16.4 Training and Test Data Separation

A Training and Test Data Separation 1620 function may enable the user to segment out the original training data into two subsets, one for training the data and one for testing the trained ML model.

### 16.5 Encoding Selection and Encoding

An Encoding Selection and Encoding 1625 function may enable the user to select the encoding scheme for categorical data. The encoding types include for example but are not limited to one-hot, ordinal, and/or nominal and/or determine how categorical data is transformed into numerical format.

### 16.6 ML Model Selection and Training

An ML Model Selection and Training 1630 function may enable the user to select the base model type (e.g., multi-layer perceptron, logistic regression, Naïve Bayes, and/or k-nearest neighbors, etc.) and/or trains the model on the selected training dataset(s).

### 16.7 Tuning and Optimization

A Tuning and Optimization 1635 function may enable the user to fine-tune the model parameters to maximize the optimization metric. The optimization metric may include for example but is not limited to Mean Absolute Error (MAE), Mean Squared Error (MSE), and/or Root Mean Squared Error (RMSE), etc.

### 16.8 Prediction Model and Hyperparameters Creation

A Prediction Model and Hyperparameters Creation 1640 function may enable a user to finalize the model parameters. For example, the user may be satisfied with the performance of the custom trained model and is ready to output the model and save it to the model library and/or storage.

### 16.9 AI/ML Models & Parameters

A AI/ML Models Parameters 1645 library and/or storage enables trained classifier ML models (and their associated parameters) to be persistently stored via the data storage for later reuse and/or retraining in other nodes and data cleansing pipelines.

### 16.10 Trained Classifier ML Model

A Trained Classifier ML Model 1650 may be the result of the model creation process. It may include one or more trained classifiers. It may be in one or more ML frameworks. It may be provided for example as a compiled model, serialized format, source code, and/or binary, etc.

### 17) Producing and Fine-Tuning a Clean Data Classifier Model

FIG. 17 depicts an example process of Producing and Fine-tuning a Clean/Dirty Classifier Model 1700, wherein a user may for example define an untrained ML model from a set of model templates, may train the model by providing it with labeled clean or dirty data, and/or may use the model to create labels for unlabeled clean or dirty data. Such a model is interacted with by a User 1705 in a graphical workspace via a custom ML node. A custom ML node enables the user to select the model template, type, name, and to set any additional parameters required by the model. A Custom ML Node & Contained Parameters 1715 may be integrated into a data cleansing pipeline, wherein it may perform data transformations (i.e., labelling) on input data passed to it via the node flow. Trained ML models may be stored stored via the data storage as model files and may be made indexable by the user for later reuse, fine-tuning, and/or retraining, etc.

### 17.1) User

A User 1705 may act as (1) the source of labeled training data ingressed into a dirty/clean classifier model, (2) the source of unlabeled data ingressed to the dirty/clean classifier model, and (3) the target for newly labeled data egressed from the dirty/clean classifier model. In (1), a User 1705 may for example provide a set of tabular data wherein each row has been assigned a label of “clean” or “dirty”. In (2), the user may for example provide a set of tabular data containing rows which may either be clean or dirty but are not labeled as such. In (3), the trained dirty/clean classifier model may for example return to the user the same dataset as was provided to it in (2), now with “dirty” and/or “clean” labels assigned to each row.

### 17.2) Training Data Labelled as Clean or Dirty

A Training Data Labelled as Clean or Dirty 1710 may be provided to an untrained Custom ML model node contains tabular data with a single column where all entries are of the set “clean” or “dirty”, indicating if the rest of the row contains exclusively clean data or at least one example of dirty data, respectively. This dataset may be used by the custom ML model node to train or retrain a dirty/clean classifier model.

### 17.3) Custom ML Node & Contained Parameters

A Custom ML Node & Container Parameter 1715 may be a node which may be added to a data cleansing pipeline to enable a user to create, train, retrain, and/or use a dirty/clean classifier model. The ML model referenced by this node may be assigned a unique Model Name 1720, allowing it to be referenced and reused across different nodes and/or in other data cleansing pipelines defined in the system. The Model Type 1725 determines the ML model template to use as a starting point before training begins. Examples include but are not limited to multi-layer perceptron, logistic regression, Naïve Bayes, k-nearest neighbors, and/or others, etc. Each model may receive zero or more additional Model Parameters 1730 that are used during the model training process. Each parameter may for example be set by the user via the node graphical user interface. Examples include but are not limited to the number of training epochs, train-test split ratio, learning rate optimization algorithm, loss function, and/or others, etc.

### 17.4) Trained Classifier ML Model

A Trained Classifier ML Model 1745 may be a dirty/clean classifier model that is produced post-training by the custom ML node. It may for example be represented as a series of weights and balances, or as another mathematical model, and may for example be persistently stored via the data storage for later reuse and/or retraining in other nodes and data cleansing pipelines. A trained dirty/clean classifier model when loaded into computer memory may for example be used to (1) label unlabeled data and/or (2) be retrained and/or fine-tuned with new labeled data.

### 17.5) Unlabeled Input Data

Unlabeled Input Data 1735 may be provided to the trained dirty/clean classifier model. For example, each row of tabular unlabeled input data may for example be assigned a label by the dirty/clean classifier model. A row may be assigned the “clean” label if and only if it contains no dirty data. A row may for example be assigned “dirty” if it contains one or more instances of dirty data.

### 17.6) Output Data Labeled as Clean or Dirty

Output Data Labeled as Clean or Dirty 1740 may be produced by the dirty/clean classifier model and is returned to the user.

### 18) Example of Cybersecurity Data Analysis

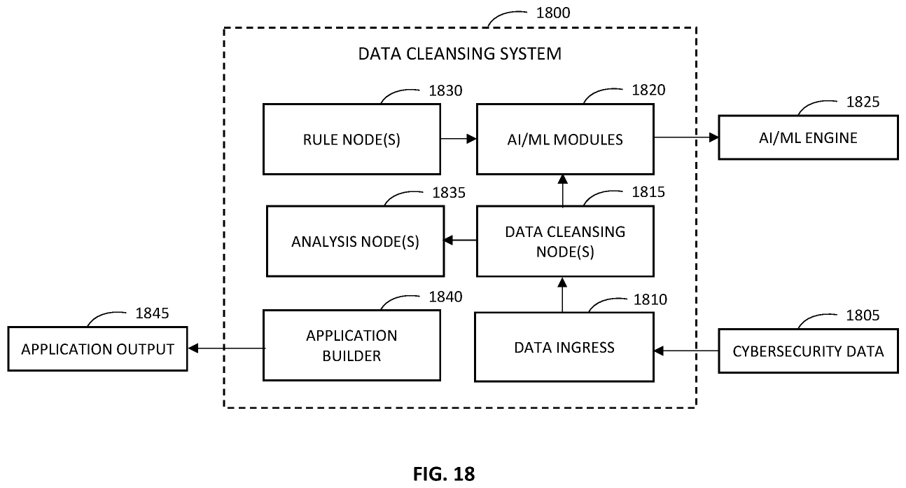

FIG. 18 depicts an example of the Data Cleansing System 1800 that illustrates how it may be used in a cybersecurity context. The Data Cleansing System 1800 may be used in use cases such as for example, but not limited to, detecting anomalies across one or more datasets from one or more tools, analyze cybersecurity tool logs, train new AI/ML models to detect cybersecurity vulnerabilities, cleanse cybersecurity data, visualize cybersecurity data, monitoring cybersecurity data, and/or generating new applications to receive, send, monitor, analyze and/or visualize cybersecurity data, etc. For example, cybersecurity data may include, but is not limited to, binary analysis, network analysis, penetration testing, security system, anti-virus, identity and access management, access control, intrusion detection system, and/or endpoint security tool, etc. Data may for example be received and/or analyzed in combination with data that is not considered cybersecurity analysis and/or tool results. For example, database logs alone may not be considered cybersecurity tool results. However, for example, a database for a hospital's patient history that has been infiltrated may have unusual usage patterns that the Data Cleansing System 1800 detects that signify that something is anomalous. For example, database logs from a hospital's patient history may be analyzed by the Data Cleansing System 1800 in combination with data from an intrusion detection system, which would assess the data through an AI/ML engine and determine with higher confidence and/or during what time period the system was hacked.

### 18.1) Cybersecurity Data

Cybersecurity Data 1805 may for example include, but is not limited to, databases, logs, tool outputs, TXT, CSV, JSON, and/or HTML, etc. Logs may for example include, but are not limited to, Windows event logs, Internet of Things (IOT) logs, endpoint logs, application logs, proxy logs, resources logs, threat logs, PCAP logs, network logs, firewall logs, browser history logs, and/or DNS logs, etc. Data may for example be received through, but is not limited to, an API, local file path, CLI, and/or CI/CD plugin, etc. Cybersecurity tools, such as for example binary analysis, traffic analysis, firewalls, malware detection, endpoint security, network protocols and access control, web vulnerability, and/or penetration tools, etc. may be integrated into a data cleansing pipeline. Databases, such as for example, but not limited to, Oracle databases, SQL databases, and/or MongoDB databases, etc., may integrate into a data cleansing pipeline, along with their usage and events logs and audits and events services. For example, Oracle databases have a large quantity of logs and audit records that get saved, such as security records, database vault records, recovery manager records, and more.

Receiving data may be configured through a node (e.g., an import file node, and/or any other node) capable of Data Ingress 1810. Data may for example be received from one or more devices, APIs, websites, and databases etc. For example, an office's system administrator may collect data from multiple devices and ingest and analyze the data in the Data Cleansing System 1800. One node within the Data Cleansing System 1800 may receive data from multiple systems, locations, and/or tools, etc. Nodes to receive data may for example be added to a data cleansing pipeline at any time.

### 18.2) Data Ingress

A Data Ingress 1810 module may include for example, but not limited to, one or more import file nodes that may allow for files to be directly uploaded, file path nodes that may allow for one or more relative and/or absolute file paths to be entered, API nodes that allow for one or more API endpoints to be configured, script nodes that enable a custom script to be run to collect data, and/or pre-built scripts that may contain cybersecurity-related code that collect data, etc. It may be manual, semi-automated, and/or automated. It may be scheduled to collect data, for example, once, multiple times, on an ongoing basis, continuously, etc. For example, an API node that fetches data from a malware detection tool may be scheduled to fetch data every week after a weekly scan is run. An API node may contain properties for configuring the API and enabling sufficient access, such as for example, but not limited to, headers, query parameters, bearer tokens, AWS signatures, form data, credentials, etc. A data cleansing pipeline may for example include its own API implementation, such as for example (but not limited to) using OpenAPI, allowing for users to send data for analysis to their application through CI/CD pipelines and/or custom cybersecurity assessment scripts and/or tools. Users may be able to create endpoints for CI/CD integrations and input parameters like the type of expected data that may be sent. There may be options for authenticated requests so that applications are secure and protected against adversarial attacks on AI/ML. Users may save and/or reuse components across applications for quicker application development. Users may integrate tools that carry out mitigations and threat responses to add as options for automated, semi-automated, and/or manual reactions to anomalous activity. Modules for cybersecurity tool types, such as network traffic analysis, may be pre-built into the Data Cleansing System 1800 to provide more seamless integration.

### 18.3) Data Cleansing Node(s)

Data Cleansing Node(s) 1815 may include zero or more nodes that may be used to for example preprocess, cleanse, normalize, and/or optimize, etc., received data. They may be optimized for example for downstream analyses, such as for example but not limited to, training an AI/ML model, performing statistical analyses, detecting anomalies, and/or visualizing data, etc. For example, for string-based data, Data Cleansing Node(s) 1815 may utilize NLP to automatically cleanse, autocorrect misspellings, normalize, and/or cluster cells of string data and/or store them as nodes in a database. Since data may be received in many different formats, a Data Cleansing Node(s) 1815 may recognize the format of data first in order to properly decode and/or store it. The preprocessor may for example separate individual logs and/or alerts, and/or filters out data that is not relevant to, for example, AI/ML. Data may for example be mapped to expected key-value pairs and/or specific nodes, etc. Mappings may be manual, semi-automated, and/or automated, and may require a human in the loop. For example, database usage logs may contain repeated information that is not valuable for analysis and/or gets automatically filtered. It may automatically extract and map dates and times of events from logs so that it can create a clear timeline of behavior and usage patterns. Users may be able to drag and drop portions of results and map them to different key-value pairs. For example, when changes are made to initial automated mappings, the Data Cleansing Node(s) 1815 may use self-learning AI/ML and improve automated mappings over time through continued use and/or collection of data.

### 18.4) AI/ML Modules

AI/ML Modules 1820 may include one or more model (for example pre-trained, fine-tuned, and/or model etc.) to be trained using the received data, etc. AI/ML Modules 1820 may act as a bridge to an AI/ML Engine 1825 that may be executed on one or more devices. An AI/ML Engine 1825 may be its own separate service that the application connects to or may be compiled with the rest of the application. For example, GPU clusters may be used to train AI/ML Modules 1820 more efficiently. One or more models may be trained, for example, from one or more AI/ML Modules 1820. AI/ML Modules 1820 may also be executed in the Data Cleansing System 1800 itself. AI/ML Modules 1820 may be trained in an AI/ML Engine 1825 but may run inference in the Data Cleansing System 1800. An AI/ML Modules 1820 may manage results from an AI/ML Engine 1825 and cross-reference them with configured thresholds and reporting requirements from one or more Rule Node(s) 1830 to make informed and useful decisions for users. More than one AI/ML Modules 1820 may be deployed to allow users to tailor analyses for example to specific systems, and/or groups of databases, etc. Each manager may be limited to the data it has permission to access. AI/ML analyses include for example, but are not limited to, categorize, highlight, remove, and/or partition alerts, anomalies, threats, weaknesses, vulnerabilities, exploits, and/or logs. For example, the data cleansing pipeline may be configured to continuously monitor data from zero or more cybersecurity tools to create a baseline of normal and/or expected behavior over a period of time and then detect anomalies and/or deviations from the baseline and alert the user. For example, the data cleansing pipeline may be configured to visualize ongoing cybersecurity alerts and their associated data. For example, the data cleansing pipeline may be used to associate data pertaining to an alert, anomaly, threat, weakness, vulnerability, exploit, and/or log with other data that occurred at the same and/or similar time. Examples of types of AI/ML models include, but are not limited to, object detection, image classifiers, natural language processing, generative models, Large Language Models (LLMs), and/or transformers, etc.

### 18.5) AI/ML Engine

An AI/ML Engine 1825 may execute AI/ML functions, such as for example but not limited to training, fine-tuning, inference, testing, validating, etc., on one or more systems. It may for example utilize NLP, deep learning, Artificial Neural Networks (ANNs), Continuous Learning (CL), and/or generative AI, etc., to for example intelligently analyze a baseline of behavior, and/or detect and/or report on anomalies, etc.

### 18.6) Rule Node(s)

Rule Node(s) 1830 may be used to configure one or more rules pertaining to one or more datasets. These may for example be in the form of limits, thresholds, allowed IPs, CVSS score limit, allowed users, etc. A rule may have subsequent actions that may be taken, such as for example performing an action. Actions may for example include, but are not limited to, ringing an alarm, sending a text message, sending an email, setting off a siren, running a Python script, sending an API call, etc. For example, thresholds may be set so that alerts are only sent if there is a large enough deviation from normal behavior. Mitigations, for example, may be mapped in the system so that one or more mitigations may take place based on one or more results from one or more AI/ML Modules 1820 and/or Analysis Node(s) 1835. Settings that may be configured include for example, but are not limited to, user and organization management, user roles and permissions, authentication, deployment options, etc. Allow and block lists may for example be constructed to aid in the creation of a baseline or to provide constants for approved and/or disapproved usage. For example, users may send a list of allowed IP addresses and/or usernames. For example, even lists may be used to influence and/or help in the creation of a baseline of normal behavior, approved IP addresses and usernames may still be flagged and marked as a threat if it is detected that there is an (e.g., insider) threat. Mitigations and threat responses may be configured in this module and set depending on the severity and confidence levels of incoming threats. For example, if an IP address is determined to be downloading data at an excessive rate, it may be configured so that the IP address is automatically blocked until a system administrator reviews the logs. A human-in-the-loop mechanism may be used to for example confirm and/or deny anomalous data detected is actually anomalous and/or if the correct responsive action was taken, etc.

### 18.7) Analysis Node(s)

Analysis Node(s) 1835 include for example, but are not limited to, scripts provided by users, scripts pre-built into the Data Cleansing System 1800, analysis tools, etc. These may include for example, but are not limited to, monitoring system behavior, system logs, device battery, memory utilization and/or storage, analyzing files, network access, and/or source code analysis, etc. Built-in assessments may be connected to a database and AI/ML Modules 1820.

### 18.8) Application Builder

An Application Builder 1840 module may compile and construct an application from Data Ingress 1810, Data Cleansing Node(s) 1815, AI/ML models, Rule Node(s) 1830, etc. It may analyze nodes from a data cleansing pipeline to compose a functional pipeline, for example to achieve a pipeline's purpose. Each node may be a generic functional block that may be compiled and built. The adaptor may customize and/or adapt for example to mission-specific data and/or the environment for the pipeline or application to deploy successfully. It may rely on configurations set in Rule Node(s) 1830. The application builder may allow users for example to save, duplicate, edit, and/or update the application and/or pipeline. Lastly, it may construct UI elements and/or connect them to compiled functional blocks.

### 18.9) Application Output

Application Output 1845 may include zero or more outputs, which may include for example, but are not limited to, a web application, mobile application, AR/VR application, pipeline (e.g., CI/CD, DevSecOps, etc.), pipeline plugin, CLI tool, data visualizations, a report, a scorecard, a list of anomalies, a list of vulnerabilities, and/or an audit report, etc.

What is claimed is:

1. A method for composing at least one data cleansing pipeline formed of at least one data transformation, the method comprising:
loading, via the processor, from a data storage, a communication, or via a user entry through a user interface, at least one input data for the at least one data cleansing pipeline;
configuring, via the processor, a series of at least one functional block and at least one connecting edge, encapsulating a sequence of data transformations in the at least one data cleansing pipeline;
visualizing properties, modifications, and/or characteristics of the data and/or data cleansing pipeline through at least one data visualization method;
testing the at least one data cleansing pipeline via real-time feedback wherein at least one configuration modification to the at least one functional block propagates an immediate change in the at least one output of the at least one data cleansing pipeline;
integrating, via the local or public computer network, external functions including at least one data ingress source, at least one data egress target, and/or at least one data transformation into the at least one data cleansing pipeline; and
finalizing the at least one data cleansing pipeline, wherein the at least one data cleansing pipeline is assigned metadata.

2. The method according to claim 1, wherein the at least one data cleansing pipeline serves the purpose of detecting, remediating, removing, sanitizing, neutralizing, modifying, deleting, or cleansing dirty data; wherein dirty data comprises of at least one of corrupt data, inaccurate data, incomplete data, incorrect data, irrelevant data, duplicate data, data containing grammatical errors, data container blank entries, data containing null entries, data sorted in an illogical order, improperly labeled data, data of an inconsistent datetime format, data that is too short, data that is too long, data containing outliers, and/or data containing anomalies.

3. The method according to claim 1, wherein the at least one data transformation comprises at least one of deduplication, substring replacement, mathematical operations, addition, multiplication, subtraction, or division, null data removal, blank data removal, empty data removal, grammatical correction, sentiment analysis, substring removal, I/O, API calls, API calls to a backend process, API calls to an external web service, data sorting, data merging, data splitting, rule validation, Boolean operations, AND, OR, NOT, XOR, encoding, outlier detection, anomaly detection, similarity detection, transposition, equality checking, data type classification, length checking, pattern matching, regular expression, find and replace, and/or AI/ML based operations, AI/ML classification and/or AI/ML prediction.

4. The method according to claim 1, wherein the at least one input data comprises at least one of tabular data, image data, binary data, hexadecimal data, signal data, text data, AI/ML training data, audio data, video data, temporal data, network data, geospatial data, and/or location data.

5. The method according to claim 1, wherein the at least one functional block comprises a graphical representation that describes the function between one or more inputs and one or more outputs, whose relationship is defined by a sequence of one or more data transformations.

6. The method according to claim 1, wherein the at least one connecting edge comprises a graphical representation that describes the flow of data from one functional block to another.

7. The method according to claim 1, wherein the at least one data visualization method comprises pie chart, bar chart, line chart, area chart, cone chart, pyramid chart, donut chart, histogram, spectrogram, cohort charts waterfall chart, funnel chart, bullet graph, diagram, scatter plot, distribution plot, box-and-whisker plot, geospatial map, and/or heat maps.

8. The method according to claim 1, wherein the at least one configuration modification comprises modifying a numeric input parameter, modifying a textual input parameter, selecting a different option from a dropdown menu, selecting a checkbox, clicking a button, reordering one or more functional blocks, adding a functional block, deleting a functional block, adding a connecting edge, deleting a connecting edge, and/or moving a connecting edge.

9. The method according to claim 1, wherein the at least one data ingress source comprises database, server, network filesystem, local filesystem, Security Event and Incident Management system (SEIM), object storage, cloud system, data bucket, data warehouse, data lake, and/or software as a service system (SAAS), and/or API call.

10. The method according to claim 1, wherein the at least one data egress target comprises at least one of database, server, network filesystem, local filesystem, Security Event and Incident Management system (SEIM), object storage, cloud system, data bucket, data warehouse, data lake, software as a service system (SAAS), API call, analysis report, user-readable analysis report, visualizations, suggestions, recommendations, scorecard, and/or machine-readable analysis report.

11. The method according to claim 1, wherein the at least one data input format comprises at least one of comma separated values (CSV), Microsoft Excel data in an XLS or XLSX format, SQL dump, plaintext (TXT), JavaScript Object Notation (JSON), Extensible Markup Language (XML), HyperText Markup Language (HTML), Microsoft Word data in a DOC or DOCX format, Joint Photographic Exprts Group in a JPG or JPEG format, Graphics Interchange Format (GIF). Portable Network Graphics (PNG), Scalable Vector Graphics (SVG), Waveform Audio File Format (WAV), MPEG-1 Audio Layer 3 (MP3), MPEG-4 Path 14 (MP4), and/or Shapefile in an SHP, SHX, or DBF format.

12. The method according to claim 1, wherein the at least one metadata comprises at least one of name, description, and/or data input format.

13. The method according to claim 1, wherein the at least one data cleansing blueprint comprises persistent storage of all functional blocks, connecting edges, AI/ML models, and input parameters required to reconstruct the at least one data cleansing pipeline, in a filesystem, database, and/or server.

14. The method according to claim 1, wherein the at least one computing system comprises at least one of a software application, command line interface, programming language, web application, desktop executable, code library, artificial intelligence system, machine learning model, simulation, control system, edge device, embedded device, information technology device, operational technology device, industrial control system, cyber-physical system, headset, mobile device, tablet device, and/or robotics system.

15. The method according to claim 1, wherein finalizing the at least one data cleansing pipeline comprises:
exporting, via the processor, to the data storage, the at least one data cleansing pipeline saved as at least one data cleansing blueprint; and/or importing, from the data storage, the data cleansing blueprint, enabling reuse of the at least one data cleansing pipeline in at least one computing system.

16. A system for composing at least one data cleansing pipeline formed of at least one data transformation comprised in the at least one computing system, the system comprising:
a processor;
a memory or a data storage that stores data and a program;
a communication device that communicates with the at least one computing system; and
a user interface that receives a user entry, wherein when the program is executed by the processor, the processor is caused to
load, via the processor, from a data storage, a communication, or via a user entry through a user interface, at least one input data for the at least one data cleansing pipeline;
configure, via the processor, a series of at least one functional block and at least one connecting edge, encapsulating a sequence of data transformations in the at least one data cleansing pipeline;
visualize properties, modifications, and/or characteristics of the data and/or data cleansing pipeline through at least one data visualization method;
test the at least one data cleansing pipeline via real-time feedback wherein at least one configuration modification to the at least one functional block propagates an immediate change in the at least one output of the at least one data cleansing pipeline;
integrate, via the local or public computer network, external functions including at least one data ingress source, at least one data egress target, and/or at least one data transformation into the at least one data cleansing pipeline; and
finalize the at least one data cleansing pipeline, wherein the at least one data cleansing pipeline is assigned metadata.

17. The system according to claim 16, wherein the at least one data cleansing pipeline serves the purpose of detecting, remediating, removing, sanitizing, neutralizing, modifying, deleting, or cleansing dirty data; wherein dirty data comprises of at least one of corrupt data, inaccurate data, incomplete data, incorrect data, irrelevant data, duplicate data, data containing grammatical errors, data container blank entries, data containing null entries, data sorted in an illogical order, improperly labeled data, data of an inconsistent datetime format, data that is too short, data that is too long, data containing outliers, and/or data containing anomalies.

18. The system according to claim 16, wherein the at least one data transformation comprises at least one of deduplication, substring replacement, mathematical operations, addition, multiplication, subtraction, or division, null data removal, blank data removal, empty data removal, grammatical correction, sentiment analysis, substring removal, I/O, API calls, API calls to a backend process, API calls to an external web service, data sorting, data merging, data splitting, rule validation, Boolean operations, AND, OR, NOT, XOR, encoding, outlier detection, anomaly detection, similarity detection, transposition, equality checking, data type classification, length checking, pattern matching, regular expression, find and replace, and/or AI/ML based operations, AI/ML classification and/or AI/ML prediction.

19. The system according to claim 16, wherein the at least one input data comprises at least one of tabular data, image data, binary data, hexadecimal data, signal data, text data, AI/ML training data, audio data, video data, temporal data, network data, geospatial data, and/or location data.

20. The system according to claim 16, wherein the at least one functional block comprises a graphical representation that describes the function between one or more inputs and one or more outputs, whose relationship is defined by a sequence of one or more data transformations.

21. The system according to claim 16, wherein the at least one connecting edge comprises a graphical representation that describes the flow of data from one functional block to another.

22. The system according to claim 16, wherein the at least one data visualization method comprises pie chart, bar chart, line chart, area chart, cone chart, pyramid chart, donut chart, histogram, spectrogram, cohort charts waterfall chart, funnel chart, bullet graph, diagram, scatter plot, distribution plot, box-and-whisker plot, geospatial map, and/or heat maps.

23. The system according to claim 16, wherein the at least one configuration modification comprises modifying a numeric input parameter, modifying a textual input parameter, selecting a different option from a dropdown menu, selecting a checkbox, clicking a button, reordering one or more functional blocks, adding a functional block, deleting a functional block, adding a connecting edge, deleting a connecting edge, and/or moving a connecting edge.

24. The system according to claim 16, wherein the at least one data ingress source comprises database, server, network filesystem, local filesystem, Security Event and Incident Management system (SEIM), object storage, cloud system, data bucket, data warehouse, data lake, and/or software as a service system (SAAS), and/or API call.

25. The system according to claim 16, wherein the at least one data egress target comprises at least one of database, server, network filesystem, local filesystem, Security Event and Incident Management system (SEIM), object storage, cloud system, data bucket, data warehouse, data lake, software as a service system (SAAS), API call, analysis report, user-readable analysis report, visualizations, suggestions, recommendations, scorecard, and/or machine-readable analysis report.

26. The system according to claim 16, wherein the at least one data input format comprises at least one of comma separated values (CSV), Microsoft Excel data in an XLS or XLSX format, SQL dump, plaintext (TXT), JavaScript Object Notation (JSON), Extensible Markup Language (XML), HyperText Markup Language (HTML), Microsoft Word data in a DOC or DOCX format, Joint Photographic Exprts Group in a JPG or JPEG format, Graphics Interchange Format (GIF). Portable Network Graphics (PNG), Scalable Vector Graphics (SVG), Waveform Audio File Format (WAV), MPEG-1 Audio Layer 3 (MP3), MPEG-4 Path 14 (MP4), and/or Shapefile in an SHP, SHX, or DBF format.

27. The system according to claim 16, wherein the at least one metadata comprises at least one of name, description, and/or data input format.

28. The system according to claim 16, wherein the at least one data cleansing blueprint comprises persistent storage of all functional blocks, connecting edges, AI/ML models, and input parameters required to reconstruct the at least one data cleansing pipeline, in a filesystem, database, and/or server.

29. The system according to claim 16, wherein the at least one computing system comprises at least one of a software application, command line interface, programming language, web application, desktop executable, code library, artificial intelligence system, machine learning model, simulation, control system, edge device, embedded device, information technology device, operational technology device, industrial control system, cyber-physical system, headset, mobile device, tablet device, and/or robotics system.

30. The system according to claim 16, wherein finalizing the at least one data cleansing pipeline comprises:
export, via the processor, to the data storage, the data cleansing pipeline saved as at least one data cleansing blueprint; and/or
import, from the data storage, the data cleansing blueprint, enabling reuse of the data cleansing pipeline in at least one computing system.
